(19) United States
(12) Patent Application Publication
(10) Pub. No.: US 2026/0369164 A1
(43) Pub. Date: Nov. 19, 2026

(54) SYSTEM AND METHOD FOR ILLUMINATED PARKING SPACE DETECTION AND GUIDANCE

(71) Applicant: American Honda Motor Co., Inc., Torrance, CA (US)

(72) Inventors: JAEBUM CHOI, IRVINE, CA (US); HYEONWOO KIM, FULLERTON, CA (US); ESTELLE GREER DYNAK STRADER, LOS ANGELES, CA (US); JENNIFER HWA-YUN WANG, SAN GABRIEL, CA (US)

(21) Appl. No.: 19/210,653

(22) Filed: May 16, 2025

(51) Int. Cl. G08G 1/14; G08G 1/0967

(52) U.S. Cl. CPC G08G 1/142; G08G 1/096766

(57) ABSTRACT

A system for illuminated parking space detection and guidance is provided. The system receives first information associated with a distance between a first vehicle and a second vehicle of a plurality of vehicles to determine a first parking slot. The system receives second information associated with an indication that a third vehicle is a parking candidate and a length of the third vehicle. The system controls emission of a first light from the first vehicle and the second vehicle. The system determines whether an available parking slot is suitable to park the third vehicle based on determined the length and the distance and controls emission of a second light from the first vehicle and the second vehicle. The system transmits information indicating the first parking slot as suitable to park the third vehicle and renders an image of the available first parking slot on a GUI of the third vehicle.

### BACKGROUND

Parking management systems have evolved with advancements in vehicle technology and urban infrastructure. These systems aim to efficiently utilize available parking spaces and guide drivers to suitable spots, particularly in crowded urban areas where parking can be challenging. Typical parking management solutions employ various techniques such as sensor networks, camera systems, and vehicle-to-infrastructure communication to monitor parking space availability. Some systems use illuminated indicators or digital displays to show vacant spots. However, these approaches often have limitations in accuracy, real-time updates, or ability to account for vehicle-specific parking requirements. Additionally, many existing systems rely on fixed infrastructure installations that can be costly to implement and maintain across large parking areas.

Further limitations and disadvantages of conventional and traditional approaches will become apparent to one of skill in the art, through comparison of described system with some aspects of the present disclosure, as set forth in the remainder of the present application and with reference to the drawings.

### SUMMARY

According to an embodiment of the disclosure, a system may be provided. The first system may include a control circuitry. The control circuitry may be configured to receive a first information from a plurality of vehicles parked at a location. The first information may be associated with at least a distance between a first vehicle and a second vehicle of the plurality of vehicles. The control circuitry may be further configured to determine based on the received first information that a first parking slot may be available between the first vehicle and the second vehicle. The control circuitry may be further configured to receive a second information from a third vehicle that approaches the plurality of vehicles. The second information may be associated with at least an indication that the third vehicle may be a parking candidate and a length of the third vehicle. The control circuitry may be further configured to control, via at least one electronic control unit (ECU) of each of the first vehicle and the second vehicle, emission of a first light from the first vehicle and the second vehicle to illuminate the available first parking slot. The emission of the first light may be controlled based on the indication that the third vehicle may be the parking candidate. The control circuitry may be further configured to determine, based on the length of the third vehicle and the distance between the first vehicle and the second vehicle, whether the available first parking slot may be suitable to park the third vehicle. The control circuitry may be further configured to control, via the at least one ECU of each of the first vehicle and the second vehicle, emission of a second light from the first vehicle and the second vehicle based on a determination that the available first parking slot is suitable to park the third vehicle. The available first parking slot determined to be suitable to park the third vehicle may be illuminated based on the second light. The control circuitry may be further configured to transmit to the third vehicle via a communication network, information associated with the available first parking slot determined to be suitable to park the third vehicle. The control circuitry may be further configured to control a display device associated with the third vehicle to render at least one image of the available first parking slot determined to be suitable to park the third vehicle on a Graphical User Interface (GUI). The at least one image of the available first parking slot determined to be suitable to park the third vehicle may be rendered based on the transmitted information.

According to another embodiment of the disclosure, a method in a system associated with a plurality of vehicles may be provided. The method may include receiving a first information from the plurality of vehicles parked at a location. The first information may be associated with at least a distance between a first vehicle and a second vehicle of the plurality of vehicles. The method may further include determining, based on the received first information, that a first parking slot may be available between the first vehicle and the second vehicle. The method may further include receiving a second information from a third vehicle that approaches the plurality of vehicles. The second information may be associated with at least an indication that the third vehicle may be a parking candidate and a length of the third vehicle. The method may further include controlling, via at least one electronic control unit (ECU) of each of the first vehicle and the second vehicle, emission of a first light from the first vehicle and the second vehicle to illuminate the available first parking slot. The emission of the first light may be controlled based on the indication that the third vehicle is the parking candidate. The method may further include determining, based on the length of the third vehicle and the distance between the first vehicle and the second vehicle, whether the available first parking slot may be suitable to park the third vehicle. The method may further include controlling, via the at least one ECU of each of the first vehicle and the second vehicle, emission of a second light from the first vehicle and the second vehicle based on a determination that the available first parking slot is suitable to park the third vehicle. The available first parking slot determined to be suitable to park the third vehicle may be illuminated based on the second light. The method may further include transmitting, to the third vehicle via a communication network, information associated with the available first parking slot determined to be suitable to park the third vehicle. The method may further include controlling, a display device associated with the third vehicle to render at least one image of the available first parking slot determined to be suitable to park the third vehicle on a Graphical User Interface (GUI). The at least one image of the available first parking slot determined to be suitable to park the third vehicle may be rendered based on the transmitted information.

According to another embodiment of the disclosure, a non-transitory computer-readable medium may be provided. The non-transitory computer-readable medium may have stored thereon computer-implemented instructions that when executed by a system associated with a plurality of vehicles, cause the system to execute operations. The operation may include receiving a first information from the plurality of vehicles parked at a location. The first information may be associated with at least a distance between a first vehicle and a second vehicle of the plurality of vehicles. The operations may further include determining, based on the received first information, that a first parking slot may be available between the first vehicle and the second vehicle. The operations may further include receiving a second information from a third vehicle that approaches the plurality of vehicles. The second information being associated with at least an indication that the third vehicle may be a parking candidate and a length of the third vehicle. The operations may further include controlling, via at least one electronic control unit (ECU) of each of the first vehicle and the second vehicle, emission of a first light from the first vehicle and the second vehicle to illuminate the available first parking slot. The emission of the first light may be controlled based on the indication that the third vehicle is the parking candidate. The operations may further include determining, based on the length of the third vehicle and the distance between the first vehicle and the second vehicle, whether the available first parking slot may be suitable to park the third vehicle. The operations may further include controlling, via the at least one ECU of each of the first vehicle and the second vehicle, emission of a second light from the first vehicle and the second vehicle based on a determination that the available first parking slot is suitable to park the third vehicle. The available first parking slot determined to be suitable to park the third vehicle may be illuminated based on the second light. The operations may further include transmitting, to the third vehicle via a communication network, information associated with the available first parking slot determined to be suitable to park the third vehicle. The operations may include controlling, a display device associated with the third vehicle to render at least one image of the available first parking slot determined to be suitable to park the third vehicle on a Graphical User Interface (GUI). The at least one image of the available first parking slot determined to be suitable to park the third vehicle may be rendered based on the transmitted information.

### BRIEF DESCRIPTION OF THE DRAWINGS

FIG. 1 is a block diagram that illustrates an exemplary network environment for parking a vehicle based on illuminated parking space detection and guidance, in accordance with an embodiment of the disclosure.

FIG. 2 is a diagram that illustrates an exemplary scenario of parking a vehicle based on illuminated parking space detection and guidance, in accordance with an embodiment of the disclosure.

FIG. 3 is a diagram that illustrates an exemplary scenario of determination that an available first parking slot is suitable to park a vehicle, in accordance with an embodiment of the disclosure.

FIG. 4A is a diagram that illustrates an exemplary scenario of turning-on of an emission of a second light from a first vehicle and a second vehicle, in accordance with an embodiment of the disclosure.

FIG. 4B is a diagram that illustrates an exemplary scenario of turning-off of an emission of a second light from a first vehicle and a second vehicle, in accordance with an embodiment of the disclosure.

FIG. 5 is a diagram that illustrate an exemplary scenario of a user instruction to turn-off of an emission of a second light from a first vehicle and a second vehicle, in accordance with an embodiment of the disclosure.

FIG. 6 is a diagram that illustrates an exemplary scenario of determination that an available first parking slot is not suitable to park a vehicle, in accordance with an embodiment of the disclosure.

FIG. 7 is a diagram that illustrates an exemplary scenario of unavailability of the first parking slot to park a vehicle at a location, in accordance with an embodiment of the disclosure.

FIG. 8A is a diagram that illustrate an exemplary scenario for determination of a first parking slot and a second parking slot available to park a vehicle, in accordance with an embodiment of the disclosure.

FIG. 8B is a diagram that illustrates an exemplary scenario for selecting a parking slot from an available first parking slot and a second parking slot that is suitable to park a vehicle, in accordance with an embodiment of the disclosure.

FIG. 8C is a diagram that illustrates an exemplary scenario for selecting a parking slot based on a user profile associated with a user of a vehicle, in accordance with an embodiment of the disclosure.

FIGS. 9A and 9B are collectively a flowchart that illustrates an exemplary method of parking a vehicle based on illuminated parking space detection and guidance, in accordance with an embodiment of the disclosure.

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

The following described implementations may be found in a system and a method for autonomous parking. Exemplary aspects of the disclosure provide a system that may comprise a circuitry. The control circuitry may be configured to receive a first information from a plurality of vehicles parked at a location. The first information may be associated with at least a distance between a first vehicle and a second vehicle of the plurality of vehicles. The control circuitry may be further configured to determine based on the received first information that a first parking slot may be available between the first vehicle and the second vehicle. The control circuitry may be further configured to receive a second information from a third vehicle that approaches the plurality of vehicles. The second information may be associated with at least an indication that the third vehicle may be a parking candidate and a length of the third vehicle. The control circuitry may be further configured to control, via at least one electronic control unit (ECU) of each of the first vehicle and the second vehicle, emission of a first light from the first vehicle and the second vehicle to illuminate the available first parking slot. The emission of the first light may be controlled based on the indication that the third vehicle may be the parking candidate. The control circuitry may be further configured to determine, based on the length of the third vehicle and the distance between the first vehicle and the second vehicle, whether the available first parking slot may be suitable to park the third vehicle. The control circuitry may be further configured to control, via the at least one ECU of each of the first vehicle and the second vehicle, emission of a second light from the first vehicle and the second vehicle based on a determination that the available first parking slot is suitable to park the third vehicle. The available first parking slot determined to be suitable to park the third vehicle may be illuminated based on the second light. The control circuitry may be further configured to transmit to the third vehicle via a communication network, information associated with the available first parking slot determined to be suitable to park the third vehicle. The control circuitry may be further configured to control a display device associated with the third vehicle to render at least one image of the available first parking slot determined to be suitable to park the third vehicle on a Graphical User Interface (GUI). The at least one image of the available first parking slot determined to be suitable to park the third vehicle may be rendered based on the transmitted information.

Existing parking management systems often face challenges in providing accurate, real-time information about available parking spaces, especially in dynamic urban environments. Current solutions typically rely on fixed infrastructure installations, which can be costly to implement and maintain across large parking areas. Additionally, many systems struggle to account for vehicle-specific parking requirements or provide personalized guidance to drivers. There is a growing need for a more flexible, efficient, and user-centric approach to parking space detection and guidance that can adapt to changing conditions and individual vehicle characteristics.

The disclosed illuminated parking space detection and guidance system utilizes a network of vehicle-based sensors and communication technologies to create a dynamic, distributed parking management solution. Unlike traditional fixed-infrastructure systems, this approach leverages the sensing and illumination capabilities of parked vehicles to detect available spaces and guide approaching vehicles. The current approach offers several advantages, including improved accuracy in detecting suitable parking spaces based on specific vehicle dimensions, real-time updates on parking availability through vehicle-to-vehicle communication, and intuitive visual guidance using illuminated indicators from parked vehicles. Furthermore, the system may adapt to changing parking conditions and user preferences, providing a more personalized and efficient parking experience.

Reference will now be made in detail to specific aspects or features, examples of which are illustrated in the accompanying drawings. Wherever possible, corresponding or similar reference numbers will be used throughout the drawings to refer to the same or corresponding parts.

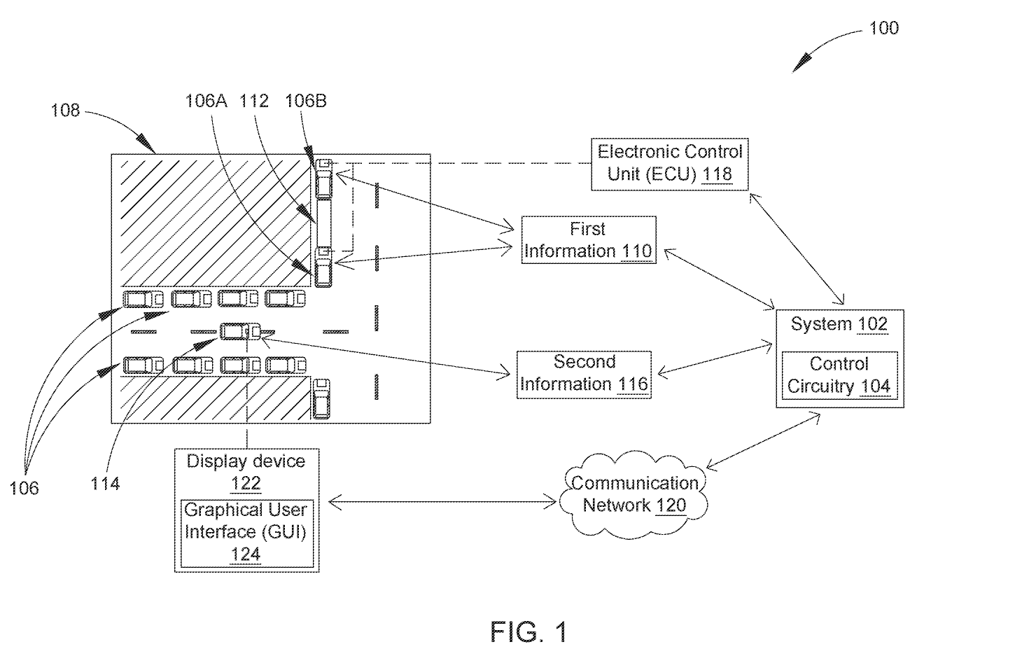

FIG. 1 is a block diagram that illustrates an exemplary network environment for parking a vehicle based on illuminated parking space detection and guidance, in accordance with an embodiment of the disclosure. With reference to FIG. 1, there is shown a network environment 100. The network environment 100 may include a system 102 having a control circuitry 104, a plurality of vehicles 106 including a first vehicle 106A and a second vehicle 106B parked at a location 108, first information 110 associated with the plurality of vehicles 106, a first parking slot 112, a third vehicle 114 approaching the plurality of vehicles 106, second information 116 associated with the third vehicle 114, an electronic control unit (ECU) 118 associated with the first vehicle 106A and the second vehicle 106B, a communication network 120, and a display device 122 having a Graphical User Interface (GUI) 124.

Each of the plurality of vehicles 106 may be a non-autonomous vehicle, a semi-autonomous vehicle, or a fully autonomous vehicle, for example, as defined by National Highway Traffic Safety Administration (NHTSA). Examples of the plurality of vehicles 106 may include, but are not limited to, a two-wheeled vehicle, a three-wheeler wheeled vehicle, a four-wheeler wheeled vehicle, a hybrid vehicle, or a vehicle with autonomous drive capability that uses one or more distinct renewable or non-renewable power sources. The plurality of vehicles 106 may use renewable or non-renewable power sources. For example, the plurality of vehicles may include a fossil fuel-based vehicle, an electric propulsion-based vehicle, a hydrogen fuel-based vehicle, a solar-powered vehicle, and/or a vehicle powered by other forms of alternative energy sources. It should be noted here that the plurality of vehicles 106 shown in FIG. 1 is a four-wheeled vehicle, which is merely an example. Though the plurality of vehicles 106 in FIG. 1 have been shown to include “N” vehicles, the scope of the present disclosure may not be so limited. The plurality of vehicles 106 may include one vehicle or more than "N” vehicles, without departing from the scope of the present disclosure. The plurality of vehicles 106 may include the first vehicle 106A and the second vehicle 106B. The first vehicle 106A and the second vehicle 106B may be any two consecutive vehicles of the plurality of vehicles 106 parked at the location 108. The present disclosure may be applicable to other types of vehicles (for example, trucks, buses, bikes, and the like). The description of such types of vehicles has been omitted from the disclosure for the sake of brevity.

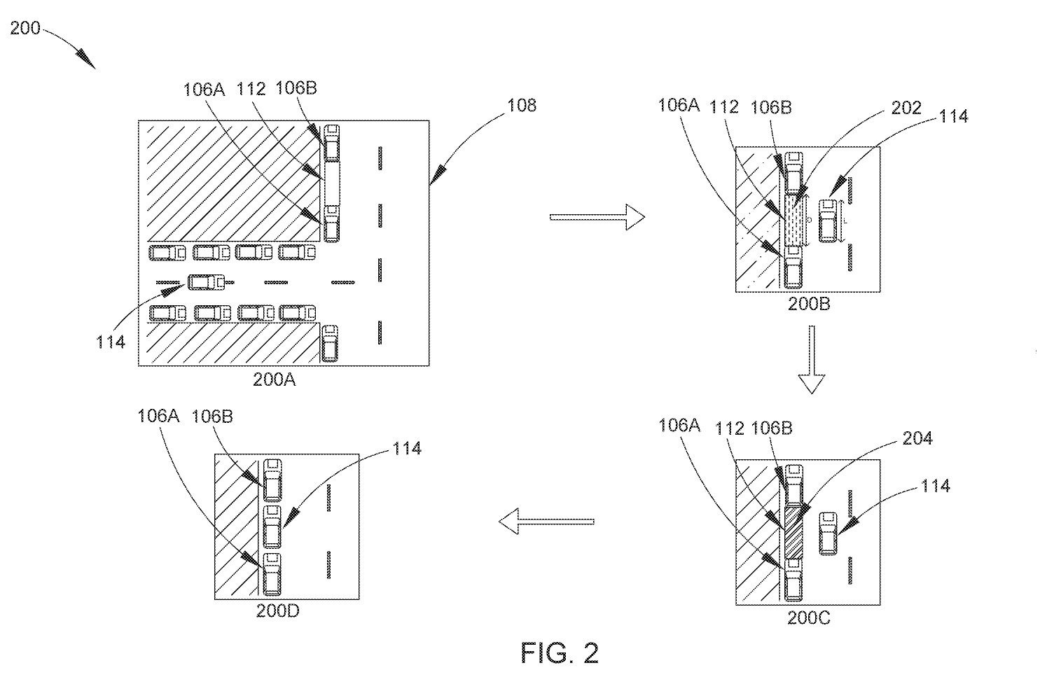

The system 102 may include the control circuitry 104 that may be configured to receive the first information 110 from the plurality of vehicles 106 parked at the location 108. The location 108 may include but not limited to parking lots, parking garages, on-street parking spaces, and private driveways. The first information 110 may be associated with at least a distance (referred henceforth as distance "D" as shown in FIGS. 2, FIG. 3, and FIG. 4A) between the first vehicle 106A and the second vehicle 106B of the plurality of vehicles 106. Examples of the system 102 may include, but are not limited to, a computing device, a smartphone, a cellular phone, a mobile phone, a computer work-station, a consumer electronic (CE) device, a vehicle remote controller device, an in-vehicle entertainment system, an advanced driver assistance system (ADAS), a user wearable device, and/or any computing device that may be capable to remotely control the plurality of vehicles 106. In an embodiment, the system 102 may be associated with at least one of a vehicle manufacturer, a vehicle dealer, a vehicle vendor, a service provider, an infrastructure provider, or the driver associated with the vehicle. Further, the system 102 may select one or more vehicles (for example, the first vehicle 106A and the second vehicle 106B) from the plurality of vehicles 106, based on the first information 110, to determine the first parking slot 112.

The control circuitry 104 may be further configured to determine based on the received first information 110, that the first parking slot 112 may be available between the first vehicle 106A and the second vehicle 106B. The first information 110 may be associated with at least the distance between the first vehicle 106A and the second vehicle 106B of the plurality of vehicles 106 as further described, in detail, for example in FIGS. 2, FIG. 3, and FIG. 4A. The distance "D" between the first vehicle 106A and the second vehicle 106B may be along a longitudinal direction of the first vehicle 106A and the second vehicle 106B. The control circuitry 104 may be configured to receive the first information 110 from the first vehicle 106A and the second vehicle 106B based on a first set of sensors (not shown) and a first set of cameras (not shown) installed within each of the first vehicle 106A and the second vehicle 106B. For example, the first set of sensors and the first set of cameras may be installed on roofs of each of the first vehicle 106A and the second vehicle 106B. In another example, the first set of sensors and the first set of cameras may be installed in one of a front cabin or a rear cabin of each of the first vehicle 106A and the second vehicle 106B. Examples of the first set of sensors may include, but are not limited to LiDAR sensors, ultrasonic sensors, infrared sensors, laser sensors, or radar sensors. The description of such types of the first set of sensors has been omitted from the disclosure without departing from the scope of the present disclosure.

In an embodiment, the control circuitry 104 may be configured to determine that the first parking slot 112 may be available between the first vehicle 106A and the second vehicle 106B based on the distance "D" between the first vehicle 106A and the second vehicle 106B being more than a predefined value. For example, the predefined value for the distance "D" between the first vehicle 106A and the second vehicle 106B is 10 feet. For an instance, if the distance "D" between the first vehicle 106A and the second vehicle 106B is 12 feet, the control circuitry 104 determines the first parking slot 112 is available between the first vehicle 106A and the second vehicle 106B. For some instances, the location 108 may include one parking slot (e.g., the first parking slot 112) or more than "N” parking slots, without departing from the scope of the present disclosure.

The control circuitry 104 may be further configured to receive the second information 116 from the third vehicle 114 that approaches the plurality of vehicles 106. The second information 116 may be associated with at least an indication that the third vehicle 114 may be a parking candidate and a length (referred henceforth as length “L” as shown in FIGS. 2, FIG. 3, and FIG. 4A) of the third vehicle 114. The control circuitry 104 may be configured to receive the second information 116 from the third vehicle 114 based on a second set of sensors (not shown) and a second set of cameras (not shown) installed within the third vehicle 114. For example, the second set of sensors and the second set of cameras may be installed on roof of the third vehicle 114. For another example, the second set of sensors and the second set of cameras may be installed in one of a front cabin or a rear cabin of the third vehicle 114. Examples of the second set of sensors may include, but are not limited to LiDAR sensors, ultrasonic sensors, infrared sensors, laser sensors, or radar sensors. The description of such types of the second set of sensors has been omitted from the disclosure without departing from the scope of the present disclosure.

In an embodiment, the control circuitry 104 may be configured to determine that the first parking slot 112 may be available between the first vehicle 106A and the second vehicle 106B based on the distance "D" between the first vehicle 106A and the second vehicle 106B is more than the length "L" of the third vehicle 114. For instance, if the length “L” of the third vehicle 114 is 10 feet and the distance "D" between the first vehicle 106A and the second vehicle 106B is 12 feet, the control circuitry 104 may determine that the first parking slot 112 is available between the first vehicle 106A and the second vehicle 106B.

The indication that the third vehicle 114 is the parking candidate may be determined based on a speed of the third vehicle 114, and the speed is within a predetermined speed range. For example, the predetermined speed range of the third vehicle 114 may be between 10 kilo meter per hour (kmph) and 20 kmph. For an instance, the third vehicle 114 may enter the location 108 at a speed of 12 kmph, and the control circuitry 104 may receive the second information 116 that includes the speed of the third vehicle 114. As the speed of the third vehicle 114 falls within the predetermined speed range, the control circuitry 104 may consider the third vehicle 114 as the parking candidate. In another example, the third vehicle 114 may enter the location 108 at a speed of 25 kmph, and the control circuitry 104 may receive the second information 116 that include the speed of the third vehicle 114. As the speed of the third vehicle 114 surpasses the predetermined speed range, the control circuitry 104 may not consider the third vehicle 114 as the parking candidate.

In an embodiment, a presence of the third vehicle 114 within a predetermined distance range from the first vehicle 106A and the second vehicle 106B is based on a predetermined value. For example, the predetermined value may be between 10 feet and 20 feet. For instance, the third vehicle 114 may enter the location 108 at a distance range of 12 feet between one of the first vehicle 106A or the second vehicle 106B and the third vehicle 114. The control circuitry 104 may receive the second information 116 that includes the predetermined distance range between one of the first vehicle 106A or the second vehicle 106B and the third vehicle 114. As the predetermined distance range between one of the first vehicle 106A or the second vehicle 106B and the third vehicle 114 falls within the predetermined value, the control circuitry 104 considers the third vehicle 114 as the parking candidate.

In another example, the third vehicle 114 may enter the location 108 at the distance range of 30 feet between one of the first vehicle 106A or the second vehicle 106B and the third vehicle 114. The control circuitry 104 receives the second information 116 that include the distance range between one of the first vehicle 106A or the second vehicle 106B and the third vehicle 114. As the distance range between one of the first vehicle 106A or the second vehicle 106B and the third vehicle 114 surpasses the predetermined distance range, the control circuitry 104 may not consider the third vehicle 114 as the parking candidate.

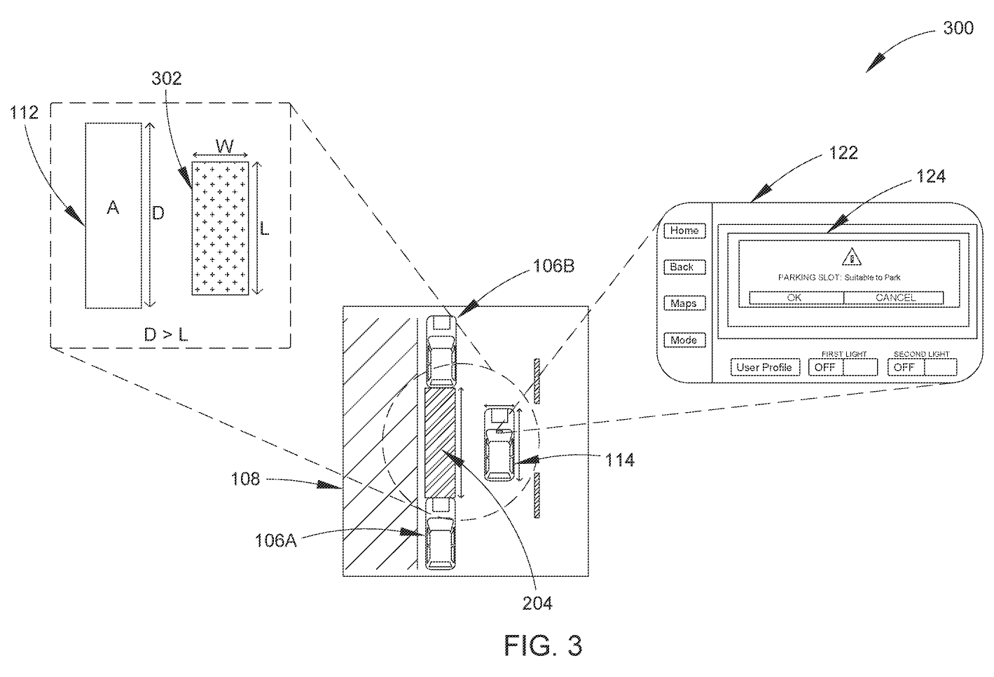

The control circuitry 104 may be further configured to control, via the at least one electronic control unit (ECU) 118 of each of the first vehicle 106A and the second vehicle 106B, emission of a first light (a first light 202 as shown in FIG. 2) from the first vehicle 106A and the second vehicle 106B to illuminate the available first parking slot 112. The emission of the first light may be controlled based on the indication that the third vehicle 114 is the parking candidate. The control circuitry 104 may be further configured to determine an area (referred henceforth as area “A” as shown in FIG. 3) of the available first parking slot 112 based on the distance "D" between the first vehicle 106A and the second vehicle 106B. The control circuitry 104 may be further configured to control the emission of the first light based on the determined area “A” of the available first parking slot 112 that exceeds a predetermined value. For example, the predetermined value of the area “A” may be between 10 square feet and 20 square feet. For an instance, the determined area “A” of the available first parking slot 112 is 16 square feet. As the determined area “A” of the available first parking slot 112 falls within the predetermined value, the control circuitry 104 controls the emission of the first light between the first vehicle 106A and the second vehicle 106B to illuminate the available first parking slot 112.

The electronic control unit (ECU) 118 may be linked with a plurality of functional components and vehicle control system of each of the first vehicle 106A and the second vehicle 106B through an in-vehicle network (not shown). The ECU 118 may include suitable logic, circuitry, interfaces, and/or code that may be configured to control operation of the plurality of functional components and vehicle control system that may be configured to control emission of the first light from the first vehicle 106A and the second vehicle 106B to illuminate the available first parking slot 112. The illumination of the available first parking slot 112 with the first light is merely an example and equivalents may be substituted without departing from the scope of the present disclosure. For some instances, the illumination of the available first parking slot 112 with the first light may include one parking slot (e.g., the first parking slot 112) or more than "N” parking slots, without departing from the scope of the present disclosure. The ECU 118 may be a specialized electronic circuitry that may include an ECU processor to control different functions, such as, but not limited to, operation of the plurality of functional components and vehicle control system, engine operations, tuning suspension system, regulating pressure of the master cylinder of brake, communication operations, and data acquisition associated with a sensor system of the first vehicle 106A and the second vehicle 106B.

The control circuitry 104 may be further configured to determine, based on the length (referred henceforth as length “L” as shown in FIG. 2 and FIG. 3) of the third vehicle 114 and the distance "D" between the first vehicle 106A and the second vehicle 106B, whether the available first parking slot 112 may be suitable to park the third vehicle 114. The control circuitry 104 may be configured to determine the available first parking slot 112 may be suitable to park the third vehicle 114 based on the distance "D" between the first vehicle 106A and the second vehicle 106B is more than the length "L" of the third vehicle 114. For an instance, if the length “L” of the third vehicle 114 may be 10 feet and the distance "D" between the first vehicle 106A and the second vehicle 106B may be 12 feet, the control circuitry 104 may determine the available first parking slot 112 is suitable to park the third vehicle 114, as further described in detail for example in FIG. 3.

The control circuitry 104 may be further configured to control, via the at least one ECU 118 of each of the first vehicle 106A and the second vehicle 106B, emission of a second light (e.g., a second light 204 as shown in FIGS. 2, FIG. 3 and FIG. 4A) from the first vehicle 106A vehicle and the second vehicle 106B vehicle based on a determination that the available first parking slot 112 is suitable to park the third vehicle 114. The available first parking slot 112 determined to be suitable to park the third vehicle 114 is illuminated based on the second light. The emission of the second light may be controlled based on the determination that the available first parking slot 112 is suitable to park the third vehicle 114. The electronic control unit (ECU) 118 may be linked with a plurality of functional components and vehicle control system of each of the first vehicle 106A and the second vehicle 106B through an in-vehicle network (not shown).

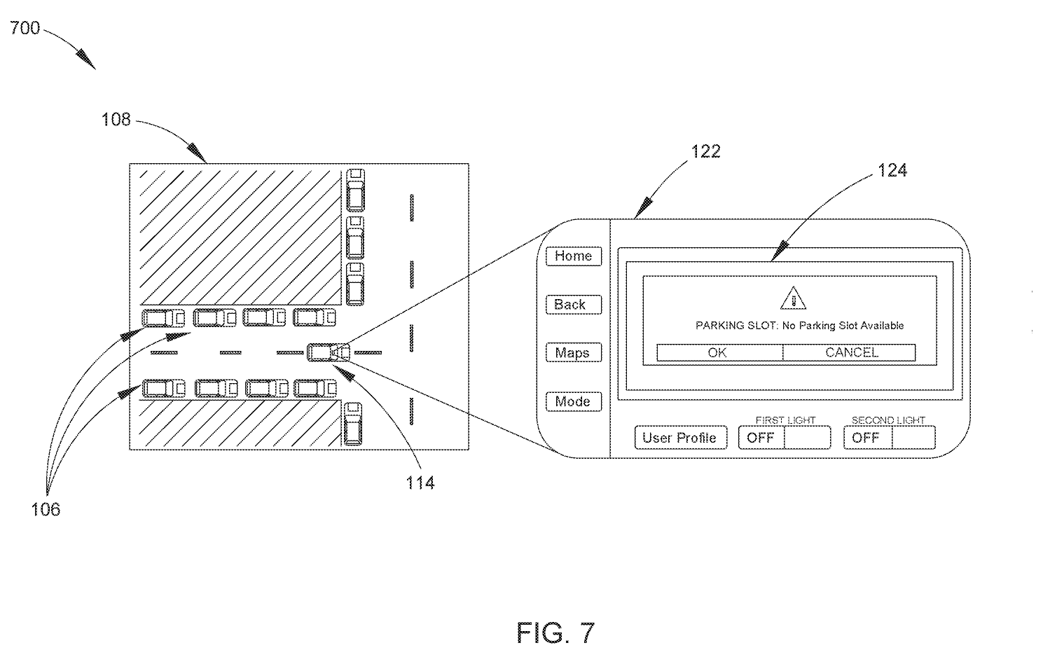

The ECU 118 may include suitable logic, circuitry, interfaces, and/or code that may be configured to control operation of the plurality of functional components and vehicle control system that may be configured to control emission of a light (e.g., the second light) from the first vehicle 106A and the second vehicle 106B based on a determination that the available first parking slot 112 is suitable to park the third vehicle 114. The illumination of the available first parking slot 112 with the second light is merely an example and equivalents may be substituted without departing from the scope of the present disclosure. The available first parking slot 112 may include one parking slot 112 or more than "N” parking slot 112 (as further described, in detail, for example in FIG. 7A), without departing from the scope of the present disclosure. For example, the third vehicle 114 enters the location 108 and based on the determination that the available first parking slot 112 is suitable to park the third vehicle 114, the control circuitry 104 controls, emission of the second light that indicates to a user or driver of the third vehicle 114 of the available first parking slot 112 suitable to park the third vehicle 114.

The control circuitry 104 may be further configured to transmit to the third vehicle 114 via the communication network 120, information associated with the available first parking slot 112 determined to be suitable to park the third vehicle 114. The communication network 120 may include a communication medium through which the system 102, the first vehicle 106A, the second vehicle 106B, and the third vehicle 114 may communicate with each other. The communication network 120 may be a wireless connection. Examples of the communication network 120 may include, but are not limited to, the Internet, a cloud network, Cellular or Wireless Mobile Network (such as Long-Term Evolution and 5G New Radio), satellite network (e.g., a network of a set of low earth orbit satellites), a Wireless Fidelity (Wi-Fi) network, a Personal Area Network (PAN), a Local Area Network (LAN), or a Metropolitan Area Network (MAN). Various devices in the network environment 100 may be configured to connect to the communication network 120 in accordance with wireless communication protocols. Examples of such communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

The communication network 120 may include at least one of a vehicle-to-vehicle (V2V) communication, a vehicle-to-infrastructure (V2I) communication or a vehicle-to-anything (V2X) communication. The vehicle-to-vehicle (V2V) communication is a technology that may enable a wireless exchange of data or information between the system 102, the first vehicle 106A, the second vehicle 106B, and the third vehicle 114 and may communicate with each other. The vehicle-to-vehicle (V2V) communication may typically use Dedicated Short-Range Communications (DSRC) or Cellular Vehicle-to-Everything (C-V2X) technology to transmit and receive data. The control circuitry 104 may be configured to receive the first information 110 and the second information 116 via the vehicle-to-vehicle (V2V) communication. The vehicle-to-vehicle (V2V) communication may be configured to allow the first vehicle 106A to transmit information to the second vehicle 106B and vice versa. The vehicle-to-vehicle (V2V) communication may be configured to allow the third vehicle 114 to transmit information to the plurality of vehicles 106 and vice versa. The vehicle-to-vehicle (V2V) communication may allow vehicles to share critical information such as their speed, position, direction, and other relevant data in real-time.The vehicle-to-vehicle (V2V) communication may be facilitated through a dedicated short-range communication (DSRC) protocol, which may operate in a 5.9 GHz band is merely an example. Additionally, the primary goal of vehicle-to-vehicle (V2V) communication may enhance road safety, improve traffic efficiency, and enable autonomous driving.

The vehicle-to-infrastructure (V2I) communication is a technology that may enable the wireless exchange of data or information between vehicles and infrastructure (for example, a road infrastructure) to communicate with each other. The infrastructure may include traffic signals, road signs, toll booths, streetlights, and other roadside units (RSUs). The vehicle-to-infrastructure (V2I) communication may typically use Dedicated Short-Range Communications (DSRC) or Cellular technology to transmit and receive data. The control circuitry 104 may be configured to receive the first information 110 and the second information 116 via the vehicle-to-infrastructure (V2I) communication. The vehicle-to-infrastructure (V2I) communication may be configured allow the first vehicle 106A to transmit information to the second vehicle 106B and vice versa. The vehicle-to-infrastructure (V2I) communication may be configured to allow the third vehicle 114 to transmit information to the plurality of vehicles 106 and vice versa. Additionally, the vehicle-to-infrastructure (V2I) communication may enhance road safety, improve traffic management, and support the development of intelligent transportation system.

The vehicle-to-anything (V2X) communication is a comprehensive technology framework that may enable the wireless exchange of information between vehicles and any entity that may affect, or be affected by, the vehicle. The entities may include other vehicles, infrastructure, pedestrians, networks, and devices The vehicle-to-anything (V2X) communication may typically use Dedicated Short-Range Communications (DSRC), Cellular Vehicle-to-Everything (C-V2X), or a combination of both technologies to transmit and receive data. The control circuitry 104 may be configured to receive the first information 110 and the second information 116 via the vehicle-to-anything (V2X) communication. The vehicle-to-anything (V2X) communication may be configured to allow the first vehicle 106A to transmit information to the second vehicle 106B and vice versa. The vehicle-to-anything (V2X) communication may be configured to allow the third vehicle 114 to transmit information to the plurality of vehicles 106 and vice versa. Additionally, vehicle-to-anything (V2X) communication may enhance road safety, improve traffic efficiency, and support the development of autonomous driving and smart transportation system.

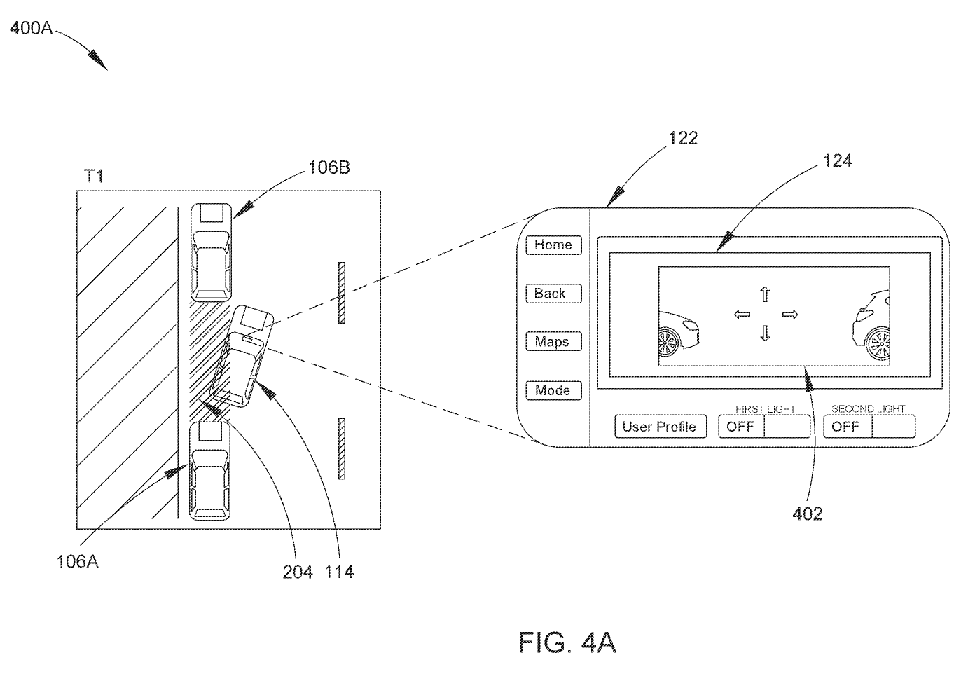

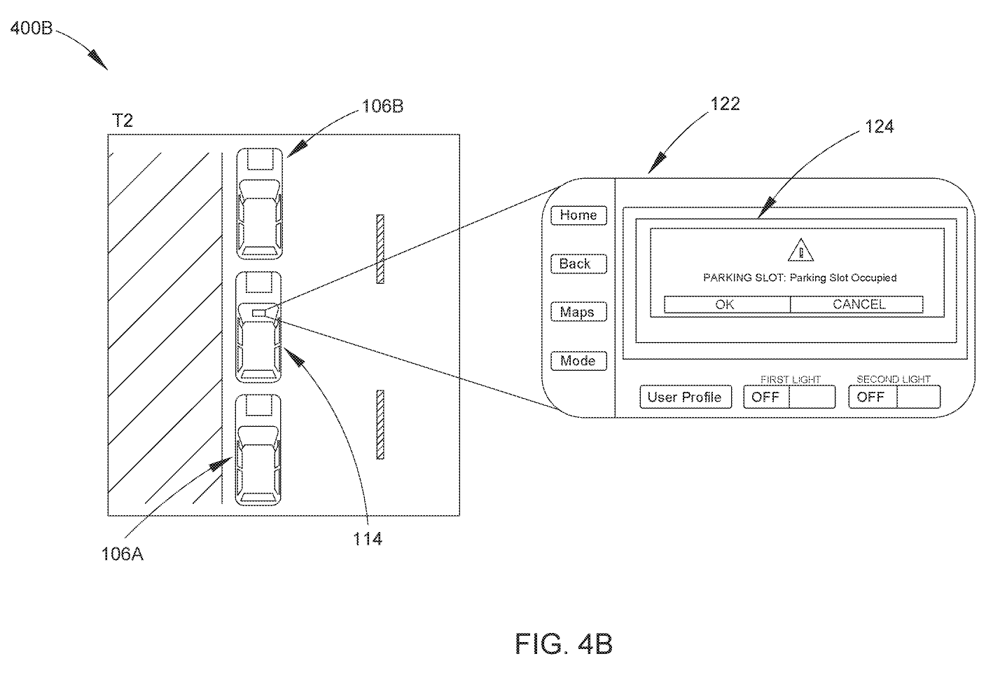

The control circuitry 104 may be further configured to control the display device 122 associated with the third vehicle 114 to render at least one image (an image 402 as shown in FIG. 4A) of the available first parking slot 112 determined to be suitable to park the third vehicle 114 on the Graphical User Interface (GUI) 124. The at least one image of the available first parking slot 112 determined to be suitable to park the third vehicle 114 may be rendered based on the transmitted information. The display device 122 may include suitable logic, circuitry, and interfaces that may be configured to display information associated with the available first parking slot 112 determined to be suitable to park the third vehicle 114. The display device 122 may be realized through several known technologies, such as but not limited to, a Liquid Crystal Display (LCD) display, a Light Emitting Diode (LED) display, a plasma display, or an Organic LED (OLED) display technology. In accordance with an embodiment, the display device 122 may refer to a display screen of a head mounted device (HMD), a smart-glass device, a see-through display, a projection-based display, an electro-chromic display, or a transparent display.

For example, if the third vehicle 114 enters the location 108 and the available first parking slot 112 is determined as suitable to park the third vehicle 114, the control circuitry 104 may transmit information associated with the available first parking slot 112 that is determined to be suitable to park the third vehicle 114. Further, the control circuitry 104 may control the display device 122 to render the at least one image of the available first parking slot 112 determined to be suitable to park the third vehicle 114. Based on the at least one image, the user or driver parks the third vehicle 114 at the available first parking slot 112.

The control circuitry 104 may be further configured to determine whether the third vehicle 114 is parked at the available first parking slot 112 that is determined to be suitable to park the third vehicle 114. The control circuitry 104 may use the first set of sensors and the first set of cameras from each of the first vehicle 106A and the second vehicle 106B to determine whether the third vehicle 114 is parked at the available first parking slot 112. Further, the control circuitry 104 may turn-off the emission of the second light from the first vehicle 106A and the second vehicle 106B based on the determination that the third vehicle 114 is parked at the available first parking slot 112 determined to be suitable to park the third vehicle 114. The control circuitry 104 may be configured to turn-off the emission of the second light from the first vehicle 106A and the second vehicle 106B based on lapse of a predetermined time after turn-on of the emission of the second light from the first vehicle 106A and the second vehicle 106B, as further described, in detail, for example in FIGS. 4A and FIG. 4B.

In operation, the system 102 may include the control circuitry 104 that may receive the first information 110 from the first vehicle 106A and the second vehicle 106B. The first information 110 may be associated with the at least distance "D" between the first vehicle 106A and the second vehicle 106B to determine that the first parking slot 112 may be available between the first vehicle 106A and the second vehicle 106B. Details related to the reception of the first information and determination that the first parking slot is available between the first vehicle and the second vehicle are further provided, for example, in FIG. 2 (at 200A) and FIG. 3.

The control circuitry 104 may be configured to receive the second information 116 from the third vehicle 114. The second information 116 may be associated with the at least an indication that the third vehicle 114 may be the parking candidate and the length "L" of the third vehicle 114. The control circuitry 104 may be further configured to control, via the at least one electronic control unit (ECU) 118 of each of the first vehicle 106A and the second vehicle 106B, emission of a first light from the first vehicle 106A and the second vehicle 106B to illuminate the available first parking slot 112. The emission of the first light may be controlled based on the indication that the third vehicle 114 is the parking candidate. Details related to the controlling the emission of the first light between the first vehicle and the second vehicle are further provided, for example, in FIG. 2 (at 200B).

The control circuitry 104 may be further configured to determine, based on the length "L" of the third vehicle 114 and the distance "D" between the first vehicle 106A and the second vehicle 106B, whether the available first parking slot 112 may be suitable to park the third vehicle 114. Details related to the determination whether the available first parking slot is suitable to park the third vehicle are further provided, for example, in FIG. 2 (at 200B) and FIG. 3.

The control circuitry 104 may be further configured to control, via the at least one ECU 118 of each of the first vehicle 106A and the second vehicle 106B, emission of a second light from the first vehicle 106A and the second vehicle 106B based on the determination that the available first parking slot 112 is suitable to park the third vehicle 114. Details related to the emission of the second light from the first vehicle and the second vehicle are further provided, for example, in FIG. 2 (at 200C) and FIG. 3.

The control circuitry 104 may be further configured to transmit to the third vehicle 114 via the communication network 120, information associated with the available first parking slot 112 determined to be suitable to park the third vehicle 114. The control circuitry 104 may be further configured to control the display device 122 associated with the third vehicle 114 to render the at least one image (an image 402 as shown in FIG. 4A) of the available first parking slot 112 determined to be suitable to park the third vehicle 114 on the Graphical User Interface (GUI) 124. Details related to controlling the display device associated with the third vehicle to render the at least one image are further provided, for example, in FIG. 2 (at 200C) and FIG. 4A.

The control circuitry 104 may be further configured to determine whether the third vehicle 114 is parked at the available first parking slot 112 determined to be suitable to park the third vehicle 114. The control circuitry 104 may be further configured to turn-off the emission of the second light from the first vehicle 106A and the second vehicle 106B based on the determination that the third vehicle 114 is parked at the available first parking slot 112 determined to be suitable to park the third vehicle 114. Details related to the turn-off the emission of the second light are further provided, for example, in FIG. 2 (at 200D) and FIG. 4B.

Existing parking management systems often face challenges in providing accurate, real-time information about available parking spaces, especially in dynamic urban environments. Current solutions typically rely on fixed infrastructure installations, which can be costly to implement and maintain across large parking areas. Additionally, many systems struggle to account for vehicle-specific parking requirements or provide personalized guidance to drivers. There is a growing need for a more flexible, efficient, and user-centric approach to parking space detection and guidance that can adapt to changing conditions and individual vehicle characteristics.

The disclosed illuminated parking space detection and guidance system (i.e., the system 102) utilizes a network of vehicle-based sensors and communication technologies to create a dynamic, distributed parking management solution. Unlike traditional fixed-infrastructure systems, this approach leverages the sensing and illumination capabilities of parked vehicles to detect available spaces and guide approaching vehicles. The current approach offers several advantages, including improved accuracy in detecting suitable parking spaces based on specific vehicle dimensions, real-time updates on parking availability through vehicle-to-vehicle communication, and intuitive visual guidance using illuminated indicators from parked vehicles. Furthermore, the disclosed system 102 may adapt to changing parking conditions and user preferences, providing a more personalized and efficient parking experience.

FIG. 2 is a diagram that illustrates an exemplary scenario of parking a vehicle based on illuminated parking space detection and guidance, in accordance with an embodiment of the disclosure. FIG. 2 is explained in conjunction with elements from FIG. 1. With reference to FIG. 2, there is shown an exemplary scenario 200 of parking a vehicle based on illuminated parking space detection and guidance. The scenario 200 includes operations from 200A to 200D that may be executed by the control circuitry 104 of the system 102.

At 200A, the plurality of vehicles 106 may be parked at the location 108 and the third vehicle 114 may enter the location 108. The control circuitry 104 may be configured to receive the first information 110 from the first vehicle 106A and the second vehicle 106B. The first information 110 may be associated with the at least distance "D" between the first vehicle 106A and the second vehicle 106B to determine that the first parking slot 112 may be available between the first vehicle 106A and the second vehicle 106B.

At 200B, the control circuitry 104 may be configured to receive the second information 116 from the third vehicle 114. The second information 116 may be associated with the at least an indication that the third vehicle 114 may be the parking candidate and the length "L" of the third vehicle 114. The indication that the third vehicle 114 is the parking candidate, is described, in detail, for example in FIG. 1. The control circuitry 104 may be further configured to control, via the at least one electronic control unit (ECU) 118 of each of the first vehicle 106A and the second vehicle 106B, emission of a first light 202 from the first vehicle 106A and the second vehicle 106B to illuminate the available first parking slot 112. The emission of the first light 202 may be controlled based on the indication that the third vehicle 114 is the parking candidate. The control circuitry 104 may be further configured to determine the area “A” of the available first parking slot 112 based on the distance "D" between the first vehicle 106A and the second vehicle 106B. The control circuitry 104 may be further configured to control the emission of the first light 202 based on the determined area “A” of the available first parking slot 112 that exceeds a predetermined value.

For example, the predetermined value of the area “A” may be between 10 square feet and 20 square feet. For an instance, the determined area “A” of the available first parking slot 112 is 16 square feet. As the determined area “A” of the available first parking slot 112 falls within the predetermined value, the control circuitry 104 controls the emission of the first light 202 between the first vehicle 106A and the second vehicle 106B. The emission of the first light 202 may be an indication to the user or driver of the third vehicle 114 that the first parking slot 112 is available to park the third vehicle 114.

The control circuitry 104 may be configured to determine, based on the length "L" of the third vehicle 114 and the distance "D" between the first vehicle 106A and the second vehicle 106B, whether the available first parking slot 112 is suitable to park the third vehicle 114, as further described, in detail, for example in FIG. 3.

At 200C, the control circuitry 104 may be configured to control, via the at least one ECU 118 of each of the first vehicle 106A and the second vehicle 106B, emission of a second light 204 from the first vehicle 106A and the second vehicle 106B based on a determination that the available first parking slot 112 is suitable to park the third vehicle 114. The available first parking slot 112 determined to be suitable to park the third vehicle 114 is illuminated based on the second light 204. The determination that the available first parking slot 112 is suitable to park the third vehicle 114 may be based on the distance "D" is greater that the length "L" is further described, in detail, for example in FIG. 3.

The ECU 118 of the first vehicle 106A and the second vehicle 106B may be configured to control emission of the second light 204 from the first vehicle 106A and the second vehicle 106B to illuminate the available first parking slot 112. The control circuitry 104 may be further configured to transmit to the third vehicle 114 via the communication network 120, information associated with the available first parking slot 112 determined to be suitable to park the third vehicle 114. The control circuitry 104 may be further configured control the display device 122 associated with the third vehicle 114 to render at least one image (e.g., an image 402 as shown in FIG. 4A) of the available first parking slot 112 determined to be suitable to park the third vehicle 114 on the Graphical User Interface (GUI) 124. The at least one image of the available first parking slot 112 determined to be suitable to park the third vehicle 114 may be rendered based on the transmitted information is further described, in detail, for example in FIG. 4A.

At 200D, the control circuitry 104 may be configured to determine whether the third vehicle 114 is parked at the available first parking slot 112 determined to be suitable to park the third vehicle 114. The control circuitry 104 may be further configured to turn-off the emission of the second light 204 from the first vehicle 106A and the second vehicle 106B based on the determination that the third vehicle 114 is parked at the available first parking slot 112 determined to be suitable to park the third vehicle 114 is further described, in detail, for example in FIG. 4B.

It should be noted that the scenario 200 of FIG. 2 is for exemplary purposes and should not be construed to limit the scope of the present disclosure.

FIG. 3 is a diagram that illustrates an exemplary scenario of determination that an available first parking slot is suitable to park a vehicle, in accordance with an embodiment of the disclosure. FIG. 3 is explained in conjunction with elements from FIGS. 1 and FIG. 2. With reference to FIG. 3, there is shown an exemplary scenario 300 including the location 108. The location 108 may include the first vehicle 106A and the second vehicle 106B of the plurality of vehicles 106, the area “A” of the available first parking slot 112, a width "W" the third vehicle 114, and a square footage 302.

The control circuitry 104 may be configured to receive the second information 116 from the third vehicle 114. The second information 116 may include the length "L" of the third vehicle 114. The second information 116 may further include the width "W" of the third vehicle 114. The control circuitry 104 may be further configured to determine the square footage 302 of the third vehicle 114 based on the length "L" of the third vehicle 114 and the width "W" of the third vehicle 114. The square footage 302 may refer to the amount of floor space available to the third vehicle 114. The square footage 302 may be calculated by multiplying the length "L" and the width "W" of the third vehicle 114.

The control circuitry 104 may be configured to determine whether the available first parking slot 112 may be suitable to park the third vehicle 114 based on the area “A” of the available first parking slot 112 that is equal to or more than the determined square footage 302 of the third vehicle 114. For example, if the length "L" of the third vehicle 114 vehicle is 10 feet and the width "W" of the third vehicle 114 is 6 feet, the square footage 302 of the third vehicle 114 is 60 square feet. Further, if the distance "D" between the first vehicle 106A and the second vehicle 106B is 12 feet and the area “A” of the first parking slot 112 is 72 square feet, then the control circuitry 104 determines that the available first parking slot 112 is suitable to park the third vehicle 114. For another example, if the length "L" of the third vehicle 114 is 10 feet and the width "W" of the third vehicle 114 is 6 feet, the square footage 302 of the third vehicle 114 is 60 square feet. Further, if the distance "D" between the first vehicle 106A and the second vehicle 106B is 10 feet and the area “A” of the first parking slot 112 is 60 square feet, then the control circuitry 104 may determine that the available first parking slot 112 is not suitable to park the third vehicle 114. The control circuitry 104 may transmit to the third vehicle 114 via the communication network 120, information associated with the available first parking slot 112 determined to be suitable to park the third vehicle 114. The control circuitry 104 may render an alert (for example “Suitable to Park”) on the display device 122, via the GUI 124.

The control circuitry 104 may be further configured to receive vehicle information associated with the third vehicle 114. The vehicle information including at least one of a vehicle model of the third vehicle 114, a vehicle type of the third vehicle 114, or a cargo size of the third vehicle 114. The control circuitry 104 may be further configured to determine the square footage 302 of the third vehicle 114 based on the received vehicle information associated with the third vehicle 114. The control circuitry 104 may be further configured to determine whether the available first parking slot 112 is suitable to park the third vehicle 114 based on the area “A” of the available first parking slot 112 that is equal to or more than the determined square footage 302 of the third vehicle 114. For example, if the cargo size of the third vehicle 114 with 11 feet long and 5 feet wide, the square footage 302 of the third vehicle 114 is 55 square feet. Further, if the area “A” of the first parking slot 112 is 60 square feet, then the control circuitry 104 determines that the available first parking slot 112 is suitable to park the third vehicle 114.

It should be noted that the exemplary scenario 300 of FIG. 3 is for exemplary purposes and should not be construed to limit the scope of the present disclosure.

FIG. 4A is a diagram that illustrates an exemplary scenario of turning-on of an emission of a second light from a first vehicle and a second vehicle, in accordance with an embodiment of the disclosure. FIG. 4A is explained in conjunction with elements from FIGS. 1, FIG. 2, and FIG. 3. With reference to FIG. 4A, there is shown an exemplary scenario 400A of turning-on of the emission of the second light 204 from the first vehicle 106A and the second vehicle 106B.

At a time instance “T1”, based on the first parking slot 112 determined to be suitable to park the third vehicle 114, the control circuitry 104 may be configured to turn-on the emission of the second light 204 from the first vehicle 106A and the second vehicle 106B via the at least one ECU 118 to illuminate the available first parking slot 112. The time instance “T1” may be a first-time instance when the control circuitry 104 may control turning-on of the emission of the second light 204 for a predetermined time. For example, the predetermined time may be greater than 10 minutes and less than 15 minutes.

The control circuitry 104 may transmit, to the third vehicle 114 via the communication network 120, information associated with the available first parking slot 112 determined to be suitable to park the third vehicle 114. The control circuitry 104 may render an alert (for example “Suitable to Park” as shown in FIG. 3) on the GUI 124. Further, the control circuitry 104 may control the display device 122 associated with the third vehicle 114 to render the at least one image 402 of the available first parking slot 112 determined to be suitable to park the third vehicle 114 on the Graphical User Interface (GUI) 124. The at least one image 402 of the available first parking slot 112 determined to be suitable to park the third vehicle 114 may be rendered based on the transmitted information. For example, the at least one image 402 may include visuals of the available first parking slot 112 that assist the user to park the third vehicle 114 on the available first parking slot 112.

It should be noted that the exemplary scenario 400A of FIG. 4A is for exemplary purposes and should not be construed to limit the scope of the present disclosure.

FIG. 4B is a diagram that illustrates an exemplary scenario of turning-off of an emission of a second light from a first vehicle and a second vehicle, in accordance with an embodiment of the disclosure. FIG. 4B is explained in conjunction with elements from FIGS. 1, FIG. 2, FIG. 3, and FIG. 4A. With reference to FIG. 4B, there is shown an exemplary scenario 400B of turning-off of the emission of the second light 204 from the first vehicle 106A and the second vehicle 106B.

The control circuitry 104 may determine whether the third vehicle 114 is parked at the available first parking slot 112 determined to be suitable to park the third vehicle 114. At a time instance “T2”, based on the determination that the third vehicle 114 is parked at the available first parking slot 112 determined to be suitable to park the third vehicle 114, the control circuitry 104 is configured to turn-off the emission of the second light 204 from the first vehicle 106A and the second vehicle 106B. The time instance “T2” may be a second-time instance when the control circuitry 104 may control turning-off of the emission of the second light 204 based on lapse of the predetermined time. For example, the predetermined time may be greater than 10 minutes and less than 15 minutes. Thus, a user may have a time window of 10 minutes to 15 minutes to park the third vehicle 114 at the available first parking slot 112 determined to be suitable to park the third vehicle 114. Further, after the time lapse of 10 minutes to 15 minutes, the control circuitry 104 may be configured to turn-off the second light 204 between the first vehicle 106A and the second vehicle 106B.

The control circuitry 104 may transmit to the third vehicle 114 via the communication network 120, information associated with the third vehicle 114 being parked at the available first parking slot 112 determined to be suitable to park the third vehicle 114 and render alert (for example “Parking Spot Occupied”) on the GUI 124. Additionally, the control circuitry 104 may transmit, to a “N” vehicle approaching the plurality of vehicles 106, via the communication network 120, information associated with the third vehicle 114 being parked at the available first parking slot 112 determined to be suitable to park the third vehicle 114 and render alert (for example “Parking Spot Occupied”) on the GUI 124 of the “N” vehicle.

It should be noted that the exemplary scenario 400B of FIG. 4B is for exemplary purposes and should not be construed to limit the scope of the present disclosure.

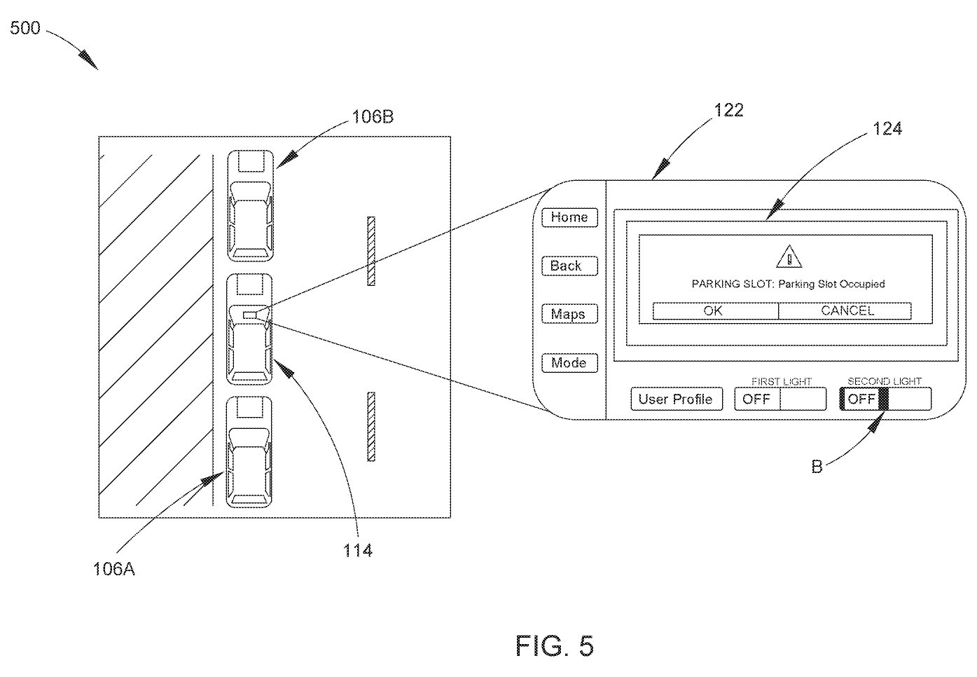

FIG. 5 is a diagram that illustrate an exemplary scenario of a user instruction to turn-off of an emission of a second light from a first vehicle and a second vehicle, in accordance with an embodiment of the disclosure. FIG. 5 is explained in conjunction with elements from FIGS. 1, FIG. 2, FIG. 3, FIG. 4A, and FIG. 4B. With reference to FIG. 5, there is shown an exemplary scenario 500 of a user instruction to turn-off of the emission of the second light 204 from the first vehicle 106A and the second vehicle 106B.

The control circuitry 104 may determine whether the third vehicle 114 is parked at the available first parking slot 112 determined to be suitable to park the third vehicle 114. The control circuitry 104 may transmit, to the third vehicle 114 via the communication network 120, information associated with the third vehicle 114 being parked at the available first parking slot 112 determined to be suitable to park the third vehicle 114 and render alert (for example “Parking Spot Occupied”) on the GUI 124, as described in detail for example, in FIG. 4B.

The control circuitry 104 may receive the user instruction to turn-off the emission of the second light 204 from the first vehicle 106A and the second vehicle 106B. The user instruction may be associated with selecting an option (for example, “OFF”) from an UI element “B” on the GUI 124. The user may manually provide the user instruction by selecting a “OFF” option from the UI element “B” on the GUI 124. Further, based on the user instruction, the control circuitry 104 may turn-off the emission of the second light 204 from the first vehicle 106A and the second vehicle 106B.

It should be noted that the exemplary scenario 500 of FIG. 5 is for exemplary purposes and should not be construed to limit the scope of the present disclosure.

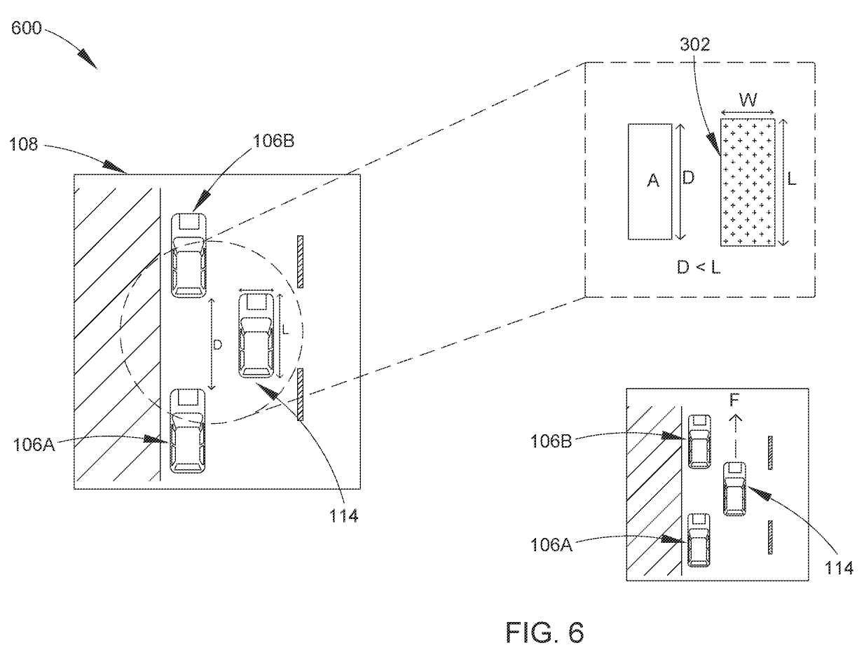

FIG. 6 is a diagram that illustrates an exemplary scenario of determination that an available first parking slot is not suitable to park a vehicle, in accordance with an embodiment of the disclosure. FIG. 6 is explained in conjunction with elements from FIGS. 1, FIG. 2, FIG. 3, FIG. 4A, FIG. 4B, and FIG. 5. With reference to FIG. 6, there is shown an exemplary scenario 600 including the location 108. The location 108 may include the first vehicle 106A and the second vehicle 106B of the plurality of vehicles 106, the area “A” of the available first parking slot 112, the length "L" and width "W" of the third vehicle 114, and the square footage 302.

The control circuitry 104 may be configured to receive the second information 116 from the third vehicle 114. The second information 116 includes the length "L" of the third vehicle 114. The second information 116 may further include the width "W" of the third vehicle 114. The control circuitry 104 may be further configured to determine the square footage 302 of the third vehicle 114 based on the length "L" of the third vehicle 114 and the width "W" of the third vehicle 114. The square footage 302 may refer to the amount of floor space available to the third vehicle 114. The square footage 302 may be calculated by multiplying the length "L" and the width "W" of the third vehicle 114.

The control circuitry 104 may be configured to determine whether the available first parking slot 112 may be suitable to park the third vehicle 114 based on the area “A” of the available first parking slot 112 that is equal to or more than the determined square footage 302 of the third vehicle 114. The control circuitry 104 may be further configured to determine the available first parking slot 112 may not be suitable to park the third vehicle 114 based on the area “A” of the available first parking slot 112 that is less than the determined square footage 302 of the third vehicle 114. For example, if the length "L" of the third vehicle 114 vehicle is 10 feet and the width "W" of the third vehicle 114 is 6 feet, the square footage 302 of the third vehicle 114 is 60 square feet. Further, if the distance "D" between the first vehicle 106A and the second vehicle 106B is 8 feet and the area “A” of the first parking slot 112 is 48 square feet, then the control circuitry 104 determines that the available first parking slot 112 is not suitable to park the third vehicle 114. The control circuitry 104 may transmit, to the third vehicle 114 via the communication network 120, information associated with the available first parking slot 112 is not suitable to park the third vehicle 114.

It should be noted that the exemplary scenario 600 of FIG. 6 is for exemplary purposes and should not be construed to limit the scope of the present disclosure.

FIG. 7 is a diagram that illustrates an exemplary scenario of unavailability of the first parking slot to park a vehicle at a location, in accordance with an embodiment of the disclosure. FIG. 7 is explained in conjunction with elements from FIGS. 1, FIG. 2, FIG. 3, FIG. 4A, FIG. 4B, FIG. 5, and FIG. 6. With reference to FIG. 7, there is shown an exemplary scenario 700 including the location 108. The location 108 may include the plurality of vehicles 106 and the third vehicle 114 approaching the plurality of vehicles 106.

The plurality of vehicles 106 may be parked at the location 108 and the third vehicle 114 may enter the location 108. The control circuitry 104 may be configured to receive the first information 110 from the first vehicle 106A and the second vehicle 106B of the plurality of vehicles 106. The first vehicle 106A and the second vehicle 106B may be any two consecutive vehicle from the plurality of vehicles 106 parked at the location 108. The first information 110 may be associated with the at least distance "D" between the first vehicle 106A and the second vehicle 106B to determine that the first parking slot 112 may be available between the first vehicle 106A and the second vehicle 106B.

The control circuitry 104 may be configured to receive the second information 116 from the third vehicle 114 that approaches the plurality of vehicles 106. The second information 116 may be associated with the length “L” of the third vehicle 114. The control circuitry 104 may be further configured to determine unavailability of the first parking slot 112 to park the third vehicle 114 based on the distance "D" between the first vehicle 106A and the second vehicle 106B is less than a predefined value. For example, the predefined value for the distance "D" between the first vehicle 106A and the second vehicle 106B is 10 feet. For an instance, the distance "D" between the first vehicle 106A and the second vehicle 106B is 8 feet, the control circuitry 104 determines unavailability of the first parking slot 112 to park the third vehicle 114.

In an embodiment, the control circuitry 104 may be configured to determine unavailable first parking slot 112 to park the third vehicle 114 based on the distance "D" between the first vehicle 106A and the second vehicle 106B is less than the length "L" of the third vehicle 114. For an instance, the length “L” of the third vehicle 114 may be 10 feet and the distance "D" between the first vehicle 106A and the second vehicle 106B may be 8 feet, the control circuitry 104 determines unavailability of the first parking slot 112 to park the third vehicle 114. The control circuitry 104 may transmit, to the third vehicle 114 via the communication network 120, information associated with the unavailability of the first parking slot 112 to park the third vehicle 114. The control circuitry 104 may render alert (for example “No Parking Slot Available”) on the GUI 124.

It should be noted that the exemplary scenario 700 of FIG. 7 is for exemplary purposes and should not be construed to limit the scope of the present disclosure.

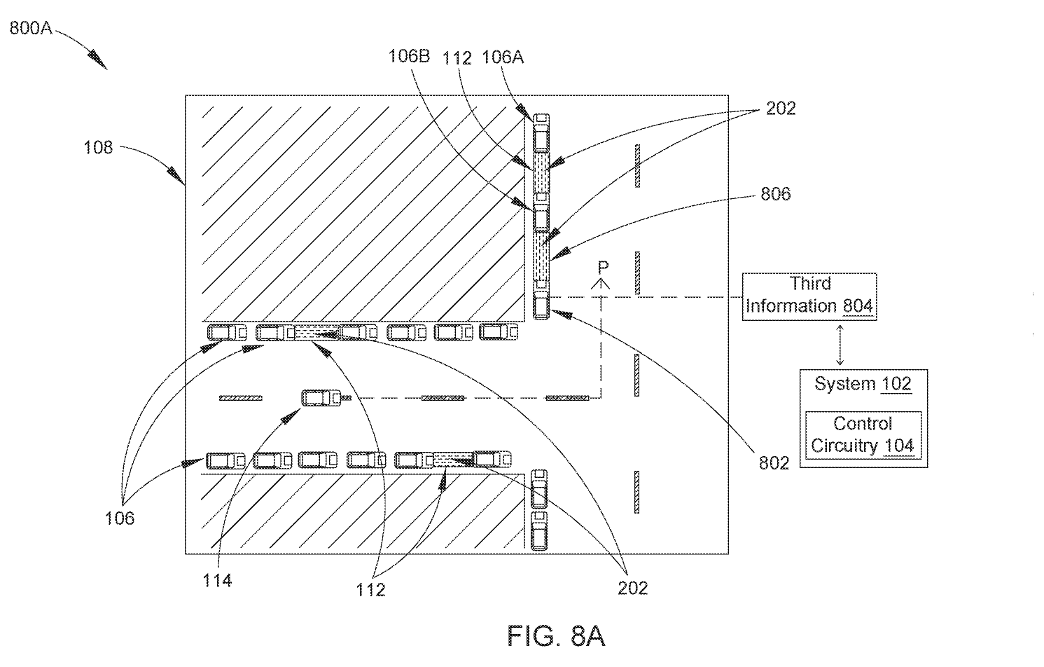

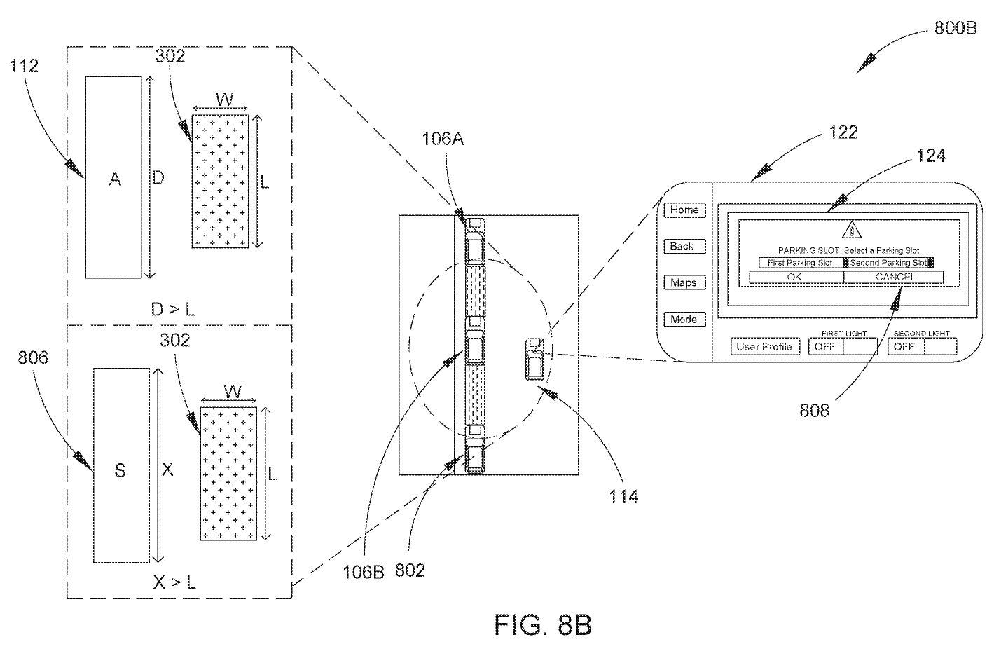

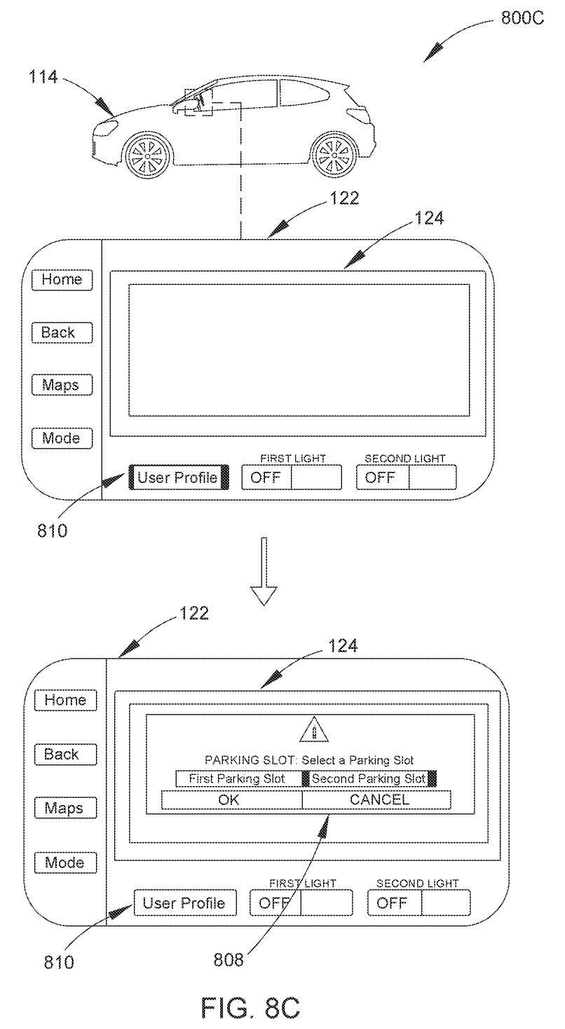

FIG. 8A is a diagram that illustrate an exemplary scenario for determination of a first parking slot and a second parking slot available to park a vehicle, in accordance with an embodiment of the disclosure. FIG. 8A is explained in conjunction with elements from FIGS. 1, FIG. 2, FIG. 3, FIG. 4A, FIG. 4B, FIG. 5, FIG. 6 and FIG. 7. With reference to FIG. 8A, there is shown an exemplary scenario 800A including the location 108. The location 108 may include the plurality of vehicles 106, the first vehicle 106A, the second vehicle 106B, the first parking slot 112, the first light 202, the third vehicle 114, a fourth vehicle 802, third information 804, and a second parking slot 806.

The plurality of vehicles 106 may be parked at the location 108 and the third vehicle 114 may enter the location 108 and move along a path “P”. The control circuitry 104 may be further configured to receive the third information 804 from the fourth vehicle 802 of the plurality of vehicles 106. The third information 804 may be associated with a distance between the fourth vehicle 802 and one of the first vehicle 106A and the second vehicle 106B. The fourth vehicle 802 may be one vehicle of the plurality of vehicles 106, without departing from the scope of the present disclosure. The description of the fourth vehicle 802 has been omitted from the disclosure for the sake of brevity. The third information 804 may be different from the first information 110. The third information 804 may be associated with a distance (referred as distance "X" henceforth as shown in FIG. 8B) between the fourth vehicle 802 and one of the first vehicle 106A and the second vehicle 106B. The distance "X" between the fourth vehicle 802 and the second vehicle 106B as shown in FIG. 8B is merely for an example without departing from the scope of the present disclosure.

The control circuitry 104 may be further configured to determine, based on the received third information 804, whether the second parking slot 806 may be available between the fourth vehicle 802 and one of the first vehicle 106A and the second vehicle 106B. Based on the distance "X" between the fourth vehicle 802 and the second vehicle 106B, the control circuitry 104 may determine the second parking slot 806 between the fourth vehicle 802 and the second vehicle 106B. The second parking slot 806 is merely an example and equivalents may be substituted without departing from the scope of the present disclosure.

In an embodiment, the control circuitry 104 may be configured to determine that the second parking slot 806 may be available between the fourth vehicle 802 and the second vehicle 106B based on the distance "X" between the fourth vehicle 802 and the second vehicle 106B is more than a predefined value. For example, the predefined value for the distance "X" between the fourth vehicle 802 and the second vehicle 106B is 10 feet. For example, if the distance "X" between the fourth vehicle 802 and the second vehicle 106B is 12 feet, the control circuitry 104 may determine that the second parking slot 806 is available between the fourth vehicle 802 and the second vehicle 106B to park the third vehicle 114. The location 108 may include the available first parking slot 112 and the second parking slot 806. For some instances, the location 108 may include the second parking slot 806 or “N” parking slots, without departing from the scope of the present disclosure.

In an embodiment, the control circuitry 104 may be configured to determine that the second parking slot 806 may be available between the fourth vehicle 802 and the second vehicle 106B based on the distance "X" between the fourth vehicle 802 and the second vehicle 106B is more than the length "L" of the third vehicle 114. For an instance, the length “L” of the third vehicle 114 may be 10 feet and the distance "X" between the fourth vehicle 802 and the second vehicle 106B may be 12 feet, the control circuitry 104 determines the second parking slot 806 is available between the fourth vehicle 802 and the second vehicle 106B to park the third vehicle 114.

The control circuitry 104 may be further configured to control, via the at least one electronic control unit (ECU) 118 of each of the first vehicle 106A, the second vehicle 106B and the fourth vehicle 802, the emission of the first light 202 from the first vehicle 106A, the second vehicle 106B and the fourth vehicle 802 to illuminate the available first parking slot 112 and the available second parking slot 806. The emission of the first light 202 from the first vehicle 106A and the second vehicle 106B to illuminate the available first parking slot 112, is described in detail, for example, in FIG. 1.

The control circuitry 104 may be configured to control, via the at least one electronic control unit (ECU) 118 of each of the fourth vehicle 802 and the second vehicle 106B, the emission of the first light 202 from the fourth vehicle 802 and the second vehicle 106B to illuminate the available second parking slot 806. The emission of the first light 202 may be controlled based on the indication that the third vehicle 114 is the parking candidate. The control circuitry 104 may be further configured to determine an area (referred henceforth as area “S” as shown in FIG. 8B) of the available second parking slot 806 based on the distance "X" between the fourth vehicle 802 and the second vehicle 106B. The control circuitry 104 may be further configured to control the emission of the first light 202 based on the determined area “S” of the available second parking slot 806 that exceeds a predetermined value.

For example, the predetermined value of the area “S” may be between 10 square feet and 20 square feet. For an instance, the determined area “S” of the available second parking slot 806 is 16 square feet. As the determined area “S” of the available first parking slot 112 falls within the predetermined value, the control circuitry 104 controls the emission of the first light 202 between the fourth vehicle 802 and the second vehicle 106B. Further, the emission of the first light 202 may be controlled based on the indication that the third vehicle 114 is the parking candidate and presence of the third vehicle 114 within a predetermined distance range from the first vehicle 106A, the second vehicle 106B and the fourth vehicle 802. The indication that the third vehicle 114 is the parking candidate, is described in detail, for example, in FIG. 1.

In an embodiment, a presence of the third vehicle 114 within a predetermined distance range from the first vehicle 106A, the second vehicle 106B and the fourth vehicle 802 is based on the predetermined value. For example, the predetermined value may be between 10 feet and 20 feet. For an instance, the third vehicle 114 may enter the location 108 at the distance range of 12 feet between one of the first vehicle 106A or the second vehicle 106B and the fourth vehicle 802. As the predetermined distance range between one of the first vehicle 106A or the second vehicle 106B and the fourth vehicle 802 falls within the predetermined value, the control circuitry 104 considers the third vehicle 114 as the parking candidate. The illumination of the available second parking slot 806 with the first light 202 is merely an example and equivalents may be substituted without departing from the scope of the present disclosure. The control circuitry 104 may illuminate the available first parking slot 112 and the available second parking slot 806 with the first light 202. For some instances, the control circuitry 104 may illuminate the second parking slot 806 or “N” parking slots with the first light 202, without departing from the scope of the present disclosure.

It should be noted that the exemplary scenario 800A of FIG. 8A is for exemplary purposes and should not be construed to limit the scope of the present disclosure.

FIG. 8B is a diagram that illustrates an exemplary scenario for selecting a parking slot from an available first parking slot and a second parking slot that is suitable to park a vehicle, in accordance with an embodiment of the disclosure. FIG. 8B is explained in conjunction with elements from FIG. 1, FIG. 2, FIG. 3, FIG. 4A, FIG. 4B, FIG. 5, FIG. 6, FIG. 7, and FIG. 8A. With reference to FIG. 8B, there is shown an exemplary scenario 800B including the location 108. The location 108 may include the first vehicle 106A, the second vehicle 106B, the fourth vehicle 802 of the plurality of vehicles 106, the distance "D" and the area “A” of the available first parking slot 112, the distance "X" and the area “S” of the available second parking slot 806, the length "L", the width "W", and the square footage 302 of the third vehicle 114, the first light 202, the second light 204, the display device 122 having the GUI 124, and an user interface (UI) element 808.

The control circuitry 104 may be further configured to determine, based on the length "L" of the third vehicle 114, the distance "D" between the first vehicle 106A and the second vehicle 106B, and the distance "X" between the fourth vehicle 802 and one of the first vehicle 106A and the second vehicle 106B, whether the available first parking slot 112 and the available second parking slot 806 are suitable to park the third vehicle 114. For example, the distance "X" between the fourth vehicle 802 and the second vehicle 106B may be equal to the distance "D" between the first vehicle 106A and the second vehicle 106B. In another example, the distance "X" between the fourth vehicle 802 and the second vehicle 106B may be less than the distance "D" between the first vehicle 106A and the second vehicle 106B. In another example, the distance "X" between the fourth vehicle 802 and the second vehicle 106B may be more than the distance "D" between the first vehicle 106A and the second vehicle 106B. The control circuitry 104 may be configured to determine whether the available first parking slot 112 is suitable to park the third vehicle 114, is described in detail, for example, in FIG. 1.

In an embodiment, the control circuitry 104 may be configured determine the available second parking slot 806 is suitable to park the third vehicle 114 based on the distance "X" between the fourth vehicle 802 and the second vehicle 106B is more than the length "L" of the third vehicle 114. For an instance, if the length “L” of the third vehicle 114 is 10 feet and the distance "X" between the fourth vehicle 802 and the second vehicle 106B is 12 feet, the control circuitry 104 may determine the available second parking slot 806 is suitable to park the third vehicle 114. Further, the control circuitry 104 may be further configured to control the display device 122 associated with the third vehicle 114 to render an option of the available first parking slot 112 and the available second parking slot 806 on the user interface (UI) element 808 on the GUI 124.

The control circuitry 104 may be further configured to select a parking slot from the available first parking slot 112 and the available second parking slot 806 based on a determination that the available first parking slot 112 and the available second parking slot 806 are suitable to park the third vehicle 114. The control circuitry 104 may be further configured to receive a user selection of one of the available first parking slot 112 and the available second parking slot 806 determined to be suitable to park the third vehicle 114 as a preferred parking slot. The user selection may be received through the user interface (UI) element 808 on in the GUI 124. For instance, in case, the preferred parking slot is the available second parking slot 806, the user selection may be the option “Second Parking Slot”.

The control circuitry 104 may be further configured to control, via the at least one electronic control unit (ECU) 118 of each of the first vehicle 106A, the second vehicle 106B and the fourth vehicle 802, the emission of the second light 204 from the first vehicle 106A, the second vehicle 106B and the fourth vehicle 802 to illuminate the selected parking slot. For instance, the preferred parking slot is the available second parking slot 806, the user may select the option “Second Parking Slot”. Further, the control circuitry 104 may control the emission of the second light 204 from the second vehicle 106B and the fourth vehicle 802 to illuminate the preferred parking slot. Additionally, the preferred parking slot may be updated in a user profile (referred henceforth as user profile 810 as shown in FIG. 8C) of the user associated with the third vehicle 114, as further described in detail, for example, in FIG. 8C.

It should be noted that the exemplary scenario 800B of FIG. 8B is for exemplary purposes and should not be construed to limit the scope of the present disclosure.

FIG. 8C is a diagram that illustrates an exemplary scenario for selecting a parking slot based on a user profile associated with a user of a vehicle, in accordance with an embodiment of the disclosure. FIG. 8C is explained in conjunction with elements from FIG. 1, FIG. 2, FIG. 3, FIG. 4A, FIG. 4B, FIG. 5, FIG. 6, FIG. 7, FIG. 8A, and FIG. 8B. With reference to FIG. 8C, there is shown an exemplary scenario 800C including the third vehicle 114. The third vehicle 114 may include the display device 122 having the GUI 124, the user interface (UI) element 808, and a user profile 810.

The control circuitry 104 may be configured to receive the user selection, on the user profile 810 of the user associated with the third vehicle 114, of one of the available first parking slot 112 and the available second parking slot 806 determined to be suitable to park the third vehicle 114. For instance, if the preferred parking slot is the available second parking slot 806, the user may select the option “Second Parking Slot”. The preferred parking slot may be updated in the user profile 810 of the user associated with the third vehicle 114.

The control circuitry 104 may be further configured to receive the user profile 810 of the user associated with the third vehicle 114. The control circuitry 104 may be configured to select the parking slot from the available first parking slot 112 and the available second parking slot 806 determined to be suitable to park the third vehicle 114 based on the received user profile 810. The user selection may be received through the user interface (UI) element 808 on in the GUI 124. Further, based on the received user profile 810, the control circuitry 104 may be configured to control the emission of the second light 204 from the first vehicle 106A, the second vehicle 106B, and the fourth vehicle 802 to illuminate the selected parking slot. For instance, the selected parking slot is the available second parking slot 806 as selected by the user from the option “Second Parking Slot”. In such a scenario, the control circuitry 104 may be configured to control the emission of the second light 204 from the second vehicle 106B and the fourth vehicle 802 and the first parking slot 112 remains illuminated based on the emission of the first light 202.

It should be noted that the exemplary scenario 800C of FIG. 8C is for exemplary purposes and should not be construed to limit the scope of the present disclosure.

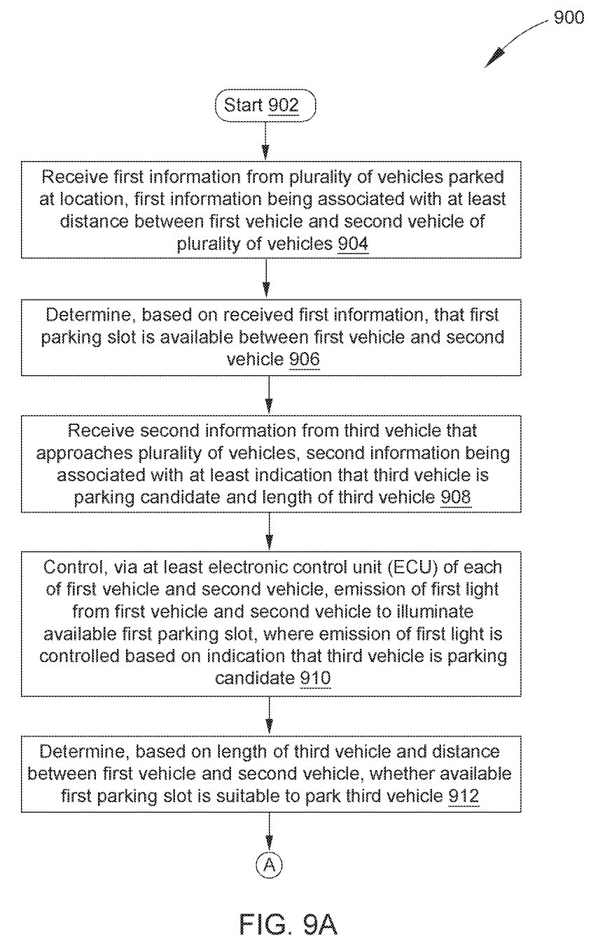

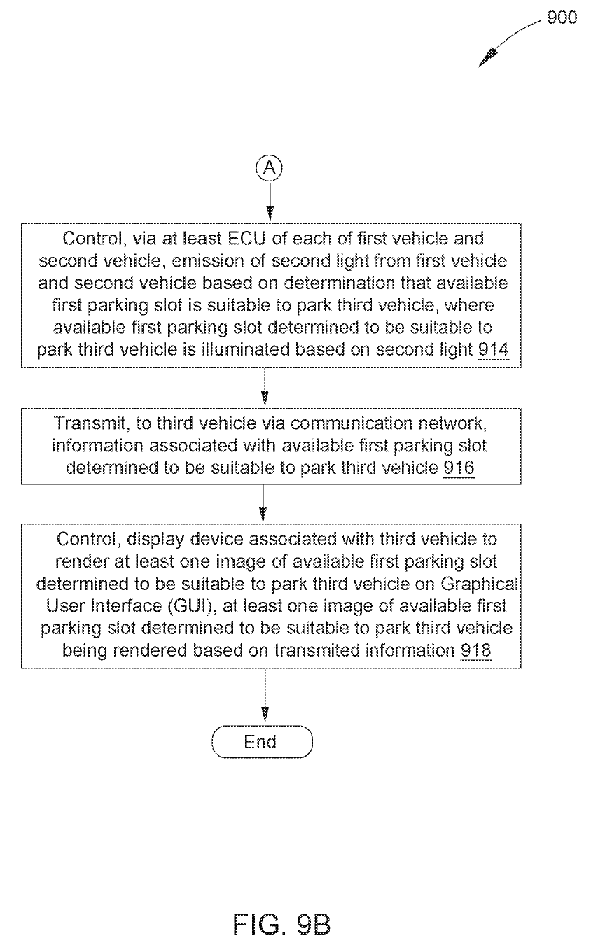

FIGS. 9A and 9B are collectively a flowchart that illustrates an exemplary method of parking a vehicle based on illuminated parking space detection and guidance, in accordance with an embodiment of the disclosure. FIGS. 9A and 9B are described in conjunction with FIG. 1, FIG. 2, FIG. 3, FIG. 4A, FIG. 4B, FIG. 5, FIG. 6, FIG. 7, FIG. 8A, FIG. 8B, and FIG. 8C. With reference to FIG. 9A and 9B, there is shown a flowchart 900, which may depict exemplary operations that are performed by an exemplary system, such as the system 102 associated with the plurality of vehicles 106 of FIG. 1 or any suitable system, apparatus, or device, such as the control circuitry 104. The method illustrated in the flowchart 900 may start at 902 and proceed to 904.

With reference to FIG. 9A, at 904, the first information 110 from the plurality of vehicles 106 parked at the location 108, may be received. The first information 110 may be associated with the at least distance "D" between the first vehicle 106A and the second vehicle 106B of the plurality of vehicles 106. The control circuitry 104 may be configured to receive the first information 110 from the plurality of vehicles 106 parked at the location 108. Details related to the reception of the first information 110 are provided, for example, in FIG. 1, FIG. 2, and FIG. 3.

At 906, the first parking slot 112 available between the first vehicle 106A and the second vehicle 106B, may be determined. The first parking slot 112 may be determined based on the received first information 110. The control circuitry 104 may be configured to determine the first parking slot 112 available between the first vehicle 106A and the second vehicle 106B. Details related to determining the first parking slot 112 available between the first vehicle 106A and the second vehicle 106B are provided, for example, in FIG. 1, FIG. 2, and FIG. 3.

At 908, the second information 116 from the third vehicle 114 that approaches the plurality of vehicles 106, may be received. The second information 116 may be associated with the at least an indication that the third vehicle 114 is a parking candidate and the length "L" of the third vehicle 114. The control circuitry 104 may be configured to receive the second information 116 from the third vehicle 114 that approaches the plurality of vehicles 106. Details related to the reception of the second information 116 are provided, for example, in FIG. 1, FIG. 2, and FIG. 3.

At 910, the emission of the first light 202 from the first vehicle 106A and the second vehicle 106B may be controlled to illuminate the available first parking slot 112, via the at least one electronic control unit (ECU) 118 of each of the first vehicle 106A and the second vehicle 106B. The emission of the first light 202 may be controlled based on the indication that the third vehicle 114 is the parking candidate. The control circuitry 104 may be configured to control the emission of the first light 202 from the first vehicle 106A and the second vehicle 106B to illuminate the available first parking slot 112, via the at least one electronic control unit (ECU) 118 of each of the first vehicle 106A and the second vehicle 106B. Details related to the controlling of the emission of the first light 202 are provided, for example, in FIG. 1 and FIG. 2.

At 912, the available first parking slot 112 suitable to park the third vehicle 114, may be determined. The available first parking slot 112 suitable to park the third vehicle 114 may be determined based on the length "L" of the third vehicle 114 and the distance "D" between the first vehicle 106A and the second vehicle 106B. The control circuitry 104 may be configured to determine the available first parking slot 112 suitable to park the third vehicle 114. Details related to the determining of the available first parking slot 112 suitable to park the third vehicle 114 are provided, for example, in FIG. 1 and FIG. 3.

With reference to FIG. 9B, at 914, the emission of the second light 204 from the first vehicle 106A and the second vehicle 106B, may be controlled. The emission of the second vehicle 106B from the first vehicle 106A and the second vehicle 106B may be controlled, via the at least one ECU 118 of each of the first vehicle 106A and the second vehicle 106B, based on the determination that the available first parking slot 112 is suitable to park the third vehicle 114. Further, the available first parking slot 112 determined to be suitable to park the third vehicle 114 may be illuminated based on the second light 204. the available first parking slot 112 suitable to park the third vehicle 114. The control circuitry 104 may be configured to control the emission of the second light 204 from the first vehicle 106A and the second vehicle 106B. Details related to controlling the emission of the second light 204 from the first vehicle 106A and the second vehicle 106B are provided, for example, in FIG. 1, FIG. 4A, FIG. 4B, and FIG. 8B.

At 916, the information associated with the available first parking slot 112 determined to be suitable to park the third vehicle 114, may be transmited. The information associated with the available first parking slot 112 may be transmitted to the third vehicle 114 via the communication network 120. The control circuitry 104 may be configured to transmit the information associated with the available first parking slot 112 determined to be suitable to park the third vehicle 114. Details related to the transmission of the information to the third vehicle 114 are provided, for example, in FIG. 1, FIG. 4A, FIG. 4B, FIG. 6, FIG. 7, FIG. 8A, and FIG. 8B.

At 918, the display device 122 associated with the third vehicle 114 to render the at least one image 402 of the available first parking slot 112 determined to be suitable to park the third vehicle 114 on the Graphical User Interface (GUI) 124, may be controlled. The at least one image 402 of the available first parking slot 112 determined to be suitable to park the third vehicle 114 may be rendered based on the transmitted information. The control circuitry 104 may be configured to control the display device 122 associated with the third vehicle 114 to render the at least one image 402 of the available first parking slot 112 determined to be suitable to park the third vehicle 114 on the Graphical User Interface (GUI) 124. Details related to the controlling the display device associated with the third vehicle 114 to render the at least one image 402 are provided, for example, in FIG. 1 and FIG. 4A. Control may pass to end.

Although the flowchart 900 is illustrated as discrete operations, such as, 904, 906, 908, 910, 912, 914, 916, and 918 the disclosure is not so limited. Accordingly, in certain embodiments, such discrete operations may be further divided into additional operations, combined into fewer operations, or eliminated, depending on the particular implementation without detracting from the essence of the disclosed embodiments.

Various embodiments of the disclosure may provide a non-transitory, computer-readable medium and/or storage medium, and/or a non-transitory machine readable medium and/or storage medium stored thereon, a set of instructions executable by a machine and/or a computer (such as, the control circuitry 104). The instructions may cause the machine and/or computer (for example, the system 102) to perform operations that may include receiving the first information 110 from the plurality of vehicles 106 parked at the location 108. The first information 110 may be associated with the at least distance "D" between the first vehicle 106A and the second vehicle 106B of the plurality of vehicles 106. The operations may further include determining, based on the received first information 110, that the first parking slot 112 may be available between the first vehicle 106A and the second vehicle 106B. The operations may further include receiving the second information 116 from the third vehicle 114 that approaches the plurality of vehicles 106. The second information 116 may be associated with the at least an indication that the third vehicle 114 may be a parking candidate and the length "L" of the third vehicle 114. The operations may further include controlling, via the at least one electronic control unit (ECU) 118 of each of the first vehicle 106A and the second vehicle 106B, emission of the first light 202 from the first vehicle 106A and the second vehicle 106B to illuminate the available first parking slot 112. The emission of the first light 202 may be controlled based on the indication that the third vehicle 114 may be the parking candidate.

Various embodiments of the disclosure may provide a non-transitory, computer-readable medium and/or storage medium, and/or a non-transitory machine readable medium and/or storage medium stored thereon, a set of instructions executable by a machine and/or a computer (such as, the control circuitry 104). The instructions may cause the machine and/or computer (for example, the system 102) to perform operations that may further include determining, based on the length "L" of the third vehicle 114 and the distance "D" between the first vehicle 106A and the second vehicle 106B, whether the available first parking slot 112 is suitable to park the third vehicle 114. The operations may further include controlling, via the at least one ECU 118 of each of the first vehicle 106A and the second vehicle 106B, emission of the second light 204 from the first vehicle 106A and the second vehicle 106B based on a determination that the available first parking slot 112 is suitable to park the third vehicle 114. The available first parking slot 112 determined to be suitable to park the third vehicle 114 is illuminated based on the second light 204. The operations may further include transmitting, to the third vehicle 114 via the communication network 120, information associated with the available first parking slot 112 determined to be suitable to park the third vehicle 114. The operations may further include controlling, the display device 122 associated with the third vehicle 114 to render the at least one image 402 of the available first parking slot 112 determined to be suitable to park the third vehicle 114 on the Graphical User Interface (GUI) 124, the at least one image 402 of the available first parking slot 112 determined to be suitable to park the third vehicle 114 may be rendered based on the transmitted information.

The present disclosure may be realized in hardware, or a combination of hardware and software. The present disclosure may be realized in a centralized fashion, in at least one computer system, or in a distributed fashion, where different elements may be spread across several interconnected computer system. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that includes a portion of an integrated circuit that also performs other functions. It may be understood that, depending on the embodiment, some of the steps described above may be eliminated, while other additional steps may be added, and the sequence of steps may be changed.

The present disclosure may also be embedded in a computer program product, which includes all the features that enable the implementation of the methods described herein, and which when loaded in a computer system is able to carry out these methods. Computer program, in the present context, means any expression, in any language, code or notation, of a set of instructions intended to cause a system with an information processing capability to perform a particular function either directly, or after either or both of the following: a) conversion to another language, code or notation; b) reproduction in a different material form. While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure is not limited to the particular embodiment disclosed, but that the present disclosure will include all embodiments that fall within the scope of the appended claims.

What is claimed is:

1. A system, comprising:
a control circuitry configured to:
receive first information from a plurality of vehicles parked at a location, the first information being associated with at least a distance between a first vehicle and a second vehicle of the plurality of vehicles;
determine, based on the received first information, that a first parking slot is available between the first vehicle and the second vehicle;
receive second information from a third vehicle that approaches the plurality of vehicles, the second information being associated with at least an indication that the third vehicle is a parking candidate and a length of the third vehicle;
control, via at least one electronic control unit (ECU) of each of the first vehicle and the second vehicle, emission of a first light from the first vehicle and the second vehicle to illuminate the available first parking slot, wherein the emission of the first light is controlled based on the indication that the third vehicle is the parking candidate;
determine, based on the length of the third vehicle and the distance between the first vehicle and the second vehicle, whether the available first parking slot is suitable to park the third vehicle;
control, via the at least one ECU of each of the first vehicle and the second vehicle, emission of a second light from the first vehicle and the second vehicle based on a determination that the available first parking slot is suitable to park the third vehicle, wherein the available first parking slot determined to be suitable to park the third vehicle is illuminated based on the second light;
transmit, to the third vehicle via a communication network, information associated with the available first parking slot determined to be suitable to park the third vehicle; and
control a display device associated with the third vehicle to render at least one image of the available first parking slot determined to be suitable to park the third vehicle on a Graphical User Interface (GUI), the at least one image of the available first parking slot determined to be suitable to park the third vehicle being rendered based on the transmitted information.

2. The system according to claim 1, wherein the indication that the third vehicle is the parking candidate is determined based on a speed of the third vehicle, and the speed is within a predetermined speed range.

3. The system according to claim 1, wherein the control circuitry is further configured to:
determine whether the third vehicle is parked at the available first parking slot determined to be suitable to park the third vehicle; and
turn-off the emission of the second light from the first vehicle and the second vehicle based on the determination that the third vehicle is parked at the available first parking slot determined to be suitable to park the third vehicle.

4. The system according to claim 1, wherein the control circuitry is further configured to
turn-off the emission of the second light from the first vehicle and the second vehicle based on lapse of a predetermined time after turn-on of the emission of the second light from the first vehicle and the second vehicle.

5. The system according to claim 1, wherein the control circuitry is further configured to:
receive a user instruction to turn-off the emission of the second light from the first vehicle and the second vehicle; and
turn-off the emission of the second light from the first vehicle and the second vehicle based on the user instruction.

6. The system according to claim 1, wherein the control circuitry is further configured to:
determine an area of the available first parking slot based on the distance between the first vehicle and the second vehicle; and
control the emission of the first light based on the determined area of the available first parking slot that exceeds a predetermined value.

7. The system according to claim 6, wherein
the second information further includes a width of the third vehicle, and
the control circuitry is further configured to:
determine a square footage of the third vehicle based on the length of the third vehicle and the width of the third vehicle; and
determine whether the available first parking slot is suitable to park the third vehicle based on the area of the available first parking slot that is equal to or more than the determined square footage of the third vehicle.

8. The system according to claim 6, wherein the control circuitry is further configured to:
receive vehicle information associated with the third vehicle, the vehicle information including at least one of: a vehicle model of the third vehicle, a vehicle type of the third vehicle, or a cargo size of the third vehicle;
determine the square footage of the third vehicle based on the received vehicle information associated with the third vehicle; and
determine whether the available first parking slot is suitable to park the third vehicle based on the area of the available first parking slot that is equal to or more than the determined square footage of the third vehicle.

9. The system according to claim 1, wherein the communication network includes at least one of: a vehicle-to-vehicle (V2V) communication, a vehicle-to-infrastructure (V2I) communication or a vehicle-to-anything (V2X) communication.

10. The system according to claim 1, wherein the control circuitry is further configured to receive the first information and the second information via at least one of: a vehicle-to-vehicle (V2V) communication, a vehicle-to-infrastructure (V2I) communication, or a vehicle-to-anything (V2X) communication.

11. The system according to claim 1, wherein the control circuitry is further configured to:
receive third information from a fourth vehicle of the plurality of vehicles, the third information being associated with a distance between the fourth vehicle and one of the first vehicle and the second vehicle;
determine, based on the received third information, whether a second parking slot is available between the fourth vehicle and one of the first vehicle and the second vehicle;
control, via the at least one electronic control unit (ECU) of each of the first vehicle, the second vehicle and the fourth vehicle, the emission of the first light from the first vehicle, the second vehicle and the fourth vehicle to illuminate the available first parking slot and the available second parking spot, wherein the emission of the first light is controlled based on the indication that the third vehicle is the parking candidate and presence of the third vehicle within a predetermined distance range from the first vehicle, the second vehicle and the fourth vehicle; and
determine, based on the length of the third vehicle, the distance between the first vehicle and the second vehicle, and the distance between the fourth vehicle and one of the first vehicle and the second vehicle, whether the available first parking slot and the available second parking spot are suitable to park the third vehicle;
select a parking slot from the available first parking slot and the available second parking slot based on a determination that the available first parking slot and the available second parking spot are suitable to park the third vehicle; and
control, via the at least one electronic control unit (ECU) of each of the first vehicle, the second vehicle and the fourth vehicle, the emission of the second light from the first vehicle, the second vehicle and the fourth vehicle to illuminate the selected parking slot.

12. The system according to claim 11, wherein the control circuitry is further configured to:
receive a user selection of one of the available first parking slot and the available second parking spot determined to be suitable to park the third vehicle as a preferred parking slot, wherein the user selection is received based on a user interface (UI) element included in the GUI;
select the parking slot from the available first parking slot and the available second parking slot determined to be suitable to park the third vehicle based on the preferred parking slot; and
control the emission of the second light from the first vehicle, the second vehicle and the fourth vehicle to illuminate the preferred parking slot.

13. The system according to claim 11, wherein the control circuitry is further configured to:
receive a user profile of a user associated with the third vehicle; and
select the parking slot from the available first parking slot and the available second parking slot determined to be suitable to park the third vehicle based on the received user profile; and
control the emission of the second light from the first vehicle, the second vehicle and the fourth vehicle to illuminate the parking slot selected based on the received user profile.

14. The system according to claim 1, wherein the control circuitry is further configured to: receive the first information from the first vehicle and the second vehicle based on a first set of sensors and a first set of cameras installed within each of the first vehicle and the second vehicle.

15. The system according to claim 1, wherein the control circuitry is further configured to receive the second information from the third vehicle based on a second set of sensors and a second set of cameras installed within the third vehicle.

16. A method, comprising:
in a system associated with a plurality of vehicles:
receiving first information from the plurality of vehicles parked at a location, the first information being associated with at least a distance between a first vehicle and a second vehicle of the plurality of vehicles;
determining, based on the received first information, that a first parking slot is available between the first vehicle and the second vehicle;
receiving second information from a third vehicle that approaches the plurality of vehicles, the second information being associated with at least an indication that the third vehicle is a parking candidate and a length of the third vehicle;
controlling, via at least one electronic control unit (ECU) of each of the first vehicle and the second vehicle, emission of a first light from the first vehicle and the second vehicle to illuminate the available first parking slot, wherein the emission of the first light is controlled based on the indication that the third vehicle is the parking candidate;
determining, based on the length of the third vehicle and the distance between the first vehicle and the second vehicle, whether the available first parking slot is suitable to park the third vehicle;
controlling, via the at least one ECU of each of the first vehicle and the second vehicle, emission of a second light from the first vehicle and the second vehicle based on a determination that the available first parking slot is suitable to park the third vehicle, wherein the available first parking slot determined to be suitable to park the third vehicle is illuminated based on the second light;
transmitting, to the third vehicle via a communication network, information associated with the available first parking slot determined to be suitable to park the third vehicle; and
controlling, a display device associated with the third vehicle to render at least one image of the available first parking slot determined to be suitable to park the third vehicle on a Graphical User Interface (GUI), the at least one image of the available first parking slot determined to be suitable to park the third vehicle being rendered based on the transmitted information.

17. The method according to claim 16, further comprising:
determining whether the third vehicle is parked at the available first parking slot determined to be suitable to park the third vehicle; and
turning-off the emission of the second light from the first vehicle and the second vehicle based on the determination that the third vehicle is parked at the available first parking slot determined to be suitable to park the third vehicle.

18. The method according to claim 16, further comprising:
turning-off the emission of the second light from the first vehicle and the second vehicle based on lapse of a predetermined time after turn-on of the emission of the second light from the first vehicle and the second vehicle.

19. The method according to claim 16, further comprising:
receiving a user instruction to turn-off the emission of the second light from the first vehicle and the second vehicle; and
turning-off the emission of the second light from the first vehicle and the second vehicle based on the user instruction.

20. A non-transitory computer-readable medium having stored thereon, computer-executable instructions which, when executed by a system associated with a plurality of vehicles, cause the system to execute operations, the operations comprising:
receiving first information from the plurality of vehicles parked at a location, the first information being associated with at least a distance between a first vehicle and a second vehicle of the plurality of vehicles;
determining, based on the received first information, that a first parking slot is available between the first vehicle and the second vehicle;
receiving second information from a third vehicle that approaches the plurality of vehicles, the second information being associated with at least an indication that the third vehicle is a parking candidate and a length of the third vehicle;
controlling, via at least one electronic control unit (ECU) of each of the first vehicle and the second vehicle, emission of a first light from the first vehicle and the second vehicle to illuminate the available first parking slot, wherein the emission of the first light is controlled based on the indication that the third vehicle is the parking candidate;
determining, based on the length of the third vehicle and the distance between the first vehicle and the second vehicle, whether the available first parking slot is suitable to park the third vehicle;
controlling, via the at least one ECU of each of the first vehicle and the second vehicle, emission of a second light from the first vehicle and the second vehicle based on a determination that the available first parking slot is suitable to park the third vehicle, wherein the available first parking slot determined to be suitable to park the third vehicle is illuminated based on the second light;
transmitting, to the third vehicle via a communication network, information associated with the available first parking slot determined to be suitable to park the third vehicle; and
controlling, a display device associated with the third vehicle to render at least one image of the available first parking slot determined to be suitable to park the third vehicle on a Graphical User Interface (GUI), the at least one image of the available first parking slot determined to be suitable to park the third vehicle being rendered based on the transmitted information.
